(19) United States
(12) Patent Application Publication
(10) Pub. No.: US 2021/0022335 A1
(43) Pub. Date: Jan. 28, 2021

(54) USE OF CYCLODEXTRINS AS AGROCHEMICAL DELIVERY SYSTEM

(71) Applicant: Adama Makhteshim Ltd., Beer Sheva (IL)

(72) Inventors: Lital Koren, Ness Ziona (IL); Shimon Amselem, Rehovot (IL); Ingo Jeschke, Salzburg (AT)

(73) Assignee: Adama Makhteshim Ltd., Beer Sheva (IL)

(21) Appl. No.: 17/046,204

(22) PCT Filed: May 8, 2019
(86) PCT No.: PCT/IB2019/053792

§ 371 Date: Oct. 8, 2020

Related U.S. Application Data
(60) Provisional application No. 62/669,741, filed on May 10, 2018.
(60) Provisional application No. 62/669,275, filed on May 9, 2018.

(51) Int. Cl. A01N 25/10; A01N 43/653; A01N 37/34

(52) U.S. Cl. CPC A01N 25/10; A01N 37/34; A01N 43/653

(57) ABSTRACT

The present invention relates to the use of cyclodextrins for increasing biological activity and improving retention and/or bioavailability of agrochemicals such as pesticides.

This application claims benefit of U.S. Provisional Application No. 62/669,741, filed May 10, 2018, and U.S. Provisional Application No. 62/669,275, filed May 9, 2018, the entire content of each of which is hereby incorporated by reference herein.

Throughout this application various publications are referenced. The disclosures of these documents in their entireties are hereby incorporated by reference into this application in order to more fully describe the state of the art to which this invention pertains.

### TECHNICAL FIELD

The present invention relates to the use of cyclodextrins as agrochemical delivery system for increasing biological activity.

### BACKGROUND

Biological activity of pesticides is affected by the ability of the active component to penetrate the target such as plant's cuticle (protective film covering the epidermis of leaves which consists of lipid and hydrocarbon polymers impregnated with wax) and its mobility through the multi-layer barrier of the leaves.

Biological activity of the pesticide/agrochemical is influenced by various parameters of the plant, the pest and the pesticide. These parameters include physical properties of the pesticide, and dispersion and contact of the pesticide over the leaves. Physical properties refer to lipophilicity, polarity, molecular weight and size.

Pesticides are organic compounds having different polarities and increasing the biological activity of a pesicide can be achieved by increasing solubility of the pesticide, preventing crystallization of the pesticide, prolonging the contact between the pesticide and the leaves, and/or reducing/evaporating of the drop medium. Efficiency of pesticide usually depends on and is affected by the ability of the active component to penetrate the barrier. Solutions of pesticides are usually more efficient and have better biological activity than suspensions where the active component is suspended as a particle.

To increase pesticide activity, adjuvants which are used to enhance solubility, adhesiveness, wetting, penetration, uptake, retention or bioavailability are added. Said adjuvants can increase the biological activity of the pesticide but can also affect the stability of the composition and thus make the formulating process more challenging.

Based on the above, there is a need in the art to find a simple and uniform solution for increasing the biological effect of pesticides and aqueous compositions which are free of additional additives.

### SUMMARY

The present invention provides a composition comprising an effective amount of a pesticide and cyclodextrin, wherein the pesticide molecules interact chemically with the cyclodextrin molecular matrix through intermolecular force(s) and wherein the pesticide is selected from triazole fungicide and pyrethroid insecticide.

The present invention provides a composition comprising an effective amount of at least one triazole fungicide and cyclodextrin, wherein the triazole fungicide molecules interact chemically with the cyclodextrin molecular matrix through intermolecular force(s).

The present invention provides a composition comprising an effective amount of at least one pyrethroid insecticide and cyclodextrin, wherein the pyrethroid insecticide molecules interact chemically with the cyclodextrin molecular matrix through intermolecular force(s).

The present invention also provides a fungicidal composition comprising (i) an effective amount of at least one triazole fungicide; (ii) cyclodextrin and (iii) an agriculturally acceptable carrier, wherein the triazole fungicide molecules interact chemically with the cyclodextrin molecular matrix through intermolecular force(s).

The present invention also provides an insecticidal composition comprising (i) an effective amount of at least one pyrethroid insecticide; (ii) cyclodextrin and (iii) an agriculturally acceptable carrier, wherein the pyrethroid insecticide molecules interact chemically with the cyclodextrin molecular matrix through intermolecular force(s).

The present invention also provides a fungicidal composition comprising (i) an effective amount of prothioconazole; (ii) cyclodextrin and (iii) an agriculturally acceptable carrier, wherein the prothioconazole molecules interact chemically with the cyclodextrin molecular matrix through intermolecular force(s).

The present invention also provides a fungicidal composition comprising (i) an effective amount of epoxiconazole; (ii) cyclodextrin and (iii) an agriculturally acceptable carrier, wherein the epoxiconazole molecules interact chemically with the cyclodextrin molecular matrix through intermolecular force(s).

The present invention also provides a fungicidal composition comprising (i) an effective amount of propiconazole; (ii) cyclodextrin and (iii) an agriculturally acceptable carrier, wherein the propiconazole molecules interact chemically with the cyclodextrin molecular matrix through intermolecular force(s).

An insecticidal composition comprising (i) an effective amount of tau-fluvalinate; (ii) cyclodextrin and (iii) an agriculturally acceptable carrier, wherein the tau-fluvalinate molecules interact chemically with the cyclodextrin molecular matrix through intermolecular force(s).

An insecticidal composition comprising (i) an effective amount of bifenthrin; (ii) cyclodextrin and (iii) an agriculturally acceptable carrier, wherein the bifenthrin molecules interact chemically with the cyclodextrin molecular matrix through intermolecular force(s).

An insecticidal composition comprising (i) an effective amount of deltamithrin; (ii) cyclodextrin and (iii) an agriculturally acceptable carrier, wherein the deltamithrin molecules interact chemically with the cyclodextrin molecular matrix through intermolecular force(s).

A fungicidal inclusion complex comprising at least one triazole fungicide and cyclodextrin.

An insecticidal inclusion complex comprising at least one pyrethroid insecticide and cyclodextrin.

A fungicidal inclusion complex comprising prothioconazole and cyclodextrin.

A fungicidal inclusion complex comprising epoxiconazole and cyclodextrin.

A fungicidal inclusion complex comprising propiconazole and cyclodextrin.

An insecticidal inclusion complex comprising tau-fluvalinate and cyclodextrin.

An insecticidal inclusion complex comprising bifenthrin and cyclodextrin.

An insecticidal inclusion complex comprising deltamithrin and cyclodextrin.

The present invention also provides a fungicidal delivery system comprising an effective amount of at least one triazole fungicide and cyclodextrin, wherein the triazole fungicide molecules interact chemically with the cyclodextrin molecular matrix through intermolecular force(s).

The present invention also provides an insecticidal delivery system comprising an effective amount of pyrethroid insecticide and cyclodextrin wherein the pyrethroid insecticide molecules interact chemically with the cyclodextrin molecular matrix through intermolecular force(s).

The present invention provides a method for improving pest control comprising applying any one of the compositions, inclusion complexes or delivery systems described herein to a plant or soil.

The present invention provides a method for prolonging the controlling effect of a pesticide selected from triazole fungicide and pyrethroid insecticide comprising applying any one of the compositions, inclusion complexes or delivery systems described herein to a plant or soil.

The present invention provides the use of cyclodextrin for increasing the fungicidal activity of triazole fungicides.

The present invention provides the use of cyclodextrin for increasing the biological activity of triazole fungicides.

The present invention provides the use of cyclodextrin for increasing the insecticidal activity of pyrethroid insecticides.

The present invention provides the use of cyclodextrin for increasing the biological activity of pyrethroid insecticides.

The present invention provides the use of cyclodextrin for enhancing the fungicidal activity of triazole fungicides.

The present invention provides the use of cyclodextrin for enhancing the insecticidal activity of pyrethroid insecticides.

The present invention provides the use of cyclodextrin for enhancing the biological activity of triazole fungicides.

The present invention provides the use of cyclodextrin for enhancing the biological activity of pyrethroid insecticides.

The present invention provides the use of cyclodextrin for increasing the fungicidal effect of prothioconazole.

The present invention provides the use of cyclodextrin for increasing the fungicidal effect of epoxiconazole.

The present invention provides the use of cyclodextrin for increasing the fungicidal effect of propiconazole.

The present invention provides the use of cyclodextrin for increasing the insecticidal effect of tau-fluvalinate.

The present invention provides the use of cyclodextrin for increasing the insecticidal effect of bifenthrin.

The present invention provides the use of cyclodextrin for increasing the insecticidal effect of deltamithrin.

The present invention provides the use of cyclodextrin for prolonging the fungicidal effect of triazole fungicide.

The present invention provides the use of cyclodextrin for prolonging the insecticidal effect of pyrethroid insecticide.

The present invention provides the use of cyclodextrin for prolonging the fungicidal effect of prothioconazole.

The present invention provides the use of cyclodextrin for prolonging the fungicidal effect of epoxiconazole.

The present invention provides the use of cyclodextrin for prolonging the fungicidal effect of propiconazole.

The present invention provides the use of cyclodextrin for prolonging the insecticidal effect of tau-fluvalinate.

The present invention provides the use of cyclodextrin for prolonging the insecticidal effect of bifenthrin.

The present invention provides the use of cyclodextrin for prolonging the insecticidal effect of deltamithrin.

The present invention provides the use of cyclodextrin for increasing retention of a triazole fungicide by a plant and/or increasing bioavailability of triazole fungicide to a plant.

The present invention provides the use of cyclodextrin for increasing retention of a pyrethroid insecticide by a plant and/or increasing bioavailability of a pyrethroid insecticide to a plant.

The present invention also provides a method for increasing biological activity of a triazole fungicide on a fungus comprising interacting the triazole fungicide with cyclodextrin through intermolecular force(s) prior to application of the triazole fungicide to a plant or soil.

The present invention also provides a method for increasing biological activity of a pyrethroid insecticide on an insect comprising interacting the pyrethroid insecticide with cyclodextrin through intermolecular force(s) prior to application of the pyrethroid insecticide to a plant or soil.

The present invention also provides a method for increasing fungicidal activity of triazole fungicide on a fungus comprising interacting the triazole fungicide with cyclodextrin through intermolecular force(s) prior to application of the triazole fungicide to a plant or soil.

The present invention also provides a method for increasing insecticidal activity of pyrethroid insecticide on an insect comprising interacting the pyrethroid insecticide with the cyclodextrin through intermolecular force(s) prior to application of the pyrethroid insecticide to a plant or soil.

The present invention also provides a method for increasing the bioavailability of a pesticide selected from triazole fungicide and pyrethroid insecticide comprising interacting the pesticide with cyclodextrin by complexing or encapsulating the pesticide molecules within the cyclodextrin molecular matrix prior to application of the pesticide to a plant or soil.

The present invention also provides a method for pest control by preventive, curative and/or persistence treatment of a plant disease caused by phytopathologic fungi comprising contacting a plant, a locus thereof or propagation material thereof with an effective amount of any one of the herein disclosed cyclodextrin compositions complexing or encapsulating the triazole fungicide.

The present invention also provides a method for pest control by preventive, curative and/or persistence treatment of a plant disease caused by insect comprising contacting a plant, a locus thereof or propagation material thereof with an effective amount of any one of the herein disclosed cyclodextrin compositions complexing or encapsulating the pyrethroid insecticide.

The present invention also provides a method for pest control by preventive, curative or persistence treatments of a plant disease caused by phytopathologic fungi comprising contacting a plant, a locus thereof or propagation material thereof with an effective amount of any one of the compositions, inclusion complexes or delivery system disclosed herein.

The present invention also provides a method for controlling unwanted insects comprising applying to an area infested with said insects an effective amount of at least one of any one of the compositions, inclusion complexes or delivery system disclosed herein.

### BRIEF DESCRIPTION OF THE DRAWINGS

FIG. 1. Phase solubility isotherms of prothioconazole-cyclodextrin complexation tendency

FIG. 2. Evolution of the curative efficacy of PTZ prototypes DT-WC-P1-W7M-1:2-05T (●) the reference PTZ fungicide Proline 50EC (▴) applied at 125ppm (A) or 250 ppm (B) 1 day or 3 days post inoculation (dpi) with pycnospores of Z. tritici strain Mg Tri-R6.

FIG. 3. Dose-Response curves for preventive efficacy, obtained from the AUDPC values, of DT-WC-P1-W7M-1:2-05T (●) and Proline EC (▴), towards Zymoseptoria tritici strain Tri-R6, Moderately resistant to DMI fungicides and Highly resistant to Qol fungicides obtained from the intensity of infection of wheat leaf fragments cultivar ALIXAN in controlled conditions.

FIG. 4. Evolution of the persistence of PTZ prototype DT-WC-P1-W7M-1:2-05T (●) the reference PTZ fungicide Proline 50EC (▴) applied at 125 ppm (A) or 250 ppm (B) and inoculated 1 week, 2 weeks or 3 weeks after the treatment with pycnosposres of Z. tritici strain Mg Tri-R6.

FIG. 5. Dose-Response curves for preventive efficacy, obtained from the AUDPC values, of DT-WC-P 1-W7M-1:2-05T (●), and Proline EC (▴), towards Phakopsora pachyrhizi strain THAI1 obtained from the AUDPC.

FIG. 6. Knockdown effect of tau-fluvalinate on 1st instars S. littoralis

FIG. 7. Knockdown effect of tau-fluvalinate on Green Peach Aphids Myzus prsicae

FIG. 8. Evolution of the curative efficacy of PTZ prototypes DT-WC-P1-W7M-1:2-05T (●) and DT-WC-P1-W7HP-1:2-06T (♦) and the reference PTZ fungicide Proline 50EC (▴) applied at 0.1 ppm (A) or 0.3 ppm (B), 3 days, or 7 days after inoculation with spores of P. pachyrhizi strain THAI_{—} in controlled conditions.

FIG. 9. Evolution of the persistence of PTZ prototypes DT-WC-P1-W7M-1:2-05T (●) and DT-WC-P1-W7HP-1:2-06T (♦) and the reference PTZ fungicide Proline 50EC (▴) applied at 0.1 ppm (A) or 0.3 ppm (B) and inoculated 1 week, 2 weeks or 3 weeks after the treatment with spores of P. pachyrhizi strain THAI.

### DETAILED DESCRIPTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter belongs.

As used herein, the term “effective” when used to describe a method for controlling undesired pest means that the method provides a good level of control of the undesired pest without significantly interfering with the normal growth and development of the crop.

As used herein, the term “effective amount” refers to an amount of the pesticide, mixture or composition that, when ingested, contacted with or sensed, is sufficient to achieve a good level of control.

As used herein, the term “agriculturally acceptable carrier” means carriers which are known and accepted in the art for the formation of compositions for agricultural or horticultural use.

As used herein, the term “adjuvant” is broadly defined as any substance that itself is not an active ingredient but which enhances or is intended to enhance the effectiveness of the pesticide with which it is used. Adjuvants may be understood to include, but not be limited to, spreading agents, penetrants, compatibility agents, and drift retardants.

As used herein, the term “agriculturally acceptable inert additives” is defined as any substance that itself is not an active ingredient but is added to the composition such as sticking agents, surfactants, synergists, anti-oxidation agent, defoaming agents and thickeners.

As used herein, the term “additive” is defined as any substance that itself is not a pesticide but is added to the composition such as sticking agents, surfactants, synergists, buffers, acidifiers, defoaming agents and thickeners.

As used herein, the term “tank mixed” means that two or more chemical pesticides or compositions are mixed in the spray tank at the time of spray application.

As used herein, the term “plant” includes reference to the whole plant, plant organ (e.g., leaves, stems, twigs, roots, trunks, limbs, shoots, fruits etc.), or plant cells.

As used herein, the term “plant” includes reference to agricultural crops including field crops (soybean, maize, wheat, rice, etc.), vegetable crops (potatoes, cabbages, etc.) and fruits (peach, ect.).

As used herein, the term “propagation material” is to be understood to denote all the generative parts of the plant such as seeds and spores, vegetative structures such as bulbs, corms, tubers, rhizomes, roots stems, basal shoots, stolons and buds.

As used herein, the term “biological activity” includes reference to pesticidal, herbicidal, insecticidal and/or nematocide activity, growth promoting activity, and enhancement of plant growth rates and yield.

As used herein, the term “cyclodextrin” refers to a family of polysaccharide compounds made up of sugar molecules bound together in a ring which may also be called cyclic oligosaccharides.

As used herein, the terms “interact chemically” or “interacted chemically” refer to a guest/host molecular structure wherein the guest molecules are complexed with and/or encapsulated within the host molecular matrix. For example, the guest agrochemical molecules are complexed with and/or encapsulated within the cyclodextrin host molecular matrix. “Interact chemically” or “interacted chemically” includes interaction through intermolecular force(s).

Guest/host molecular structure refers to the complex of a guest agrochemical molecule with the host cyclodextrin molecule and/or encapsulation of the guest agrochemical molecule within the host cyclodextrin molecular matrix.

Complex may refer to inclusion complex.

As used herein, the term “intermolecular force(s)” may include, but is not limited to, non-covalent interactions such ionic interactions, hydrogen bonds, dipole-dipole interactions, van der Waals interactions and hydrophobic interactions.

As used herein, the term “locus” includes not only areas where pest may already be growing, but also areas where pest have yet to emerge, and also to areas under cultivation. Pests include, but is not limited to, phytopathogenic fungi and unwanted insects.

As used herein, the term “ha” refers to hectare.

As used herein, the term “mixture” or “combination” refers, but is not limited to, a combination in any physical form, e.g., blend, solution, suspension, dispersion, emulsion, alloy, or the like.

As used herein, the term “substantially free of any adjuvant” or “substantially free of an adjuvant” means that the composition contains an amount of adjuvant that does not significantly affect the biological activity of the pesticide. In preferred embodiments, the adjuvant is in amount of less than 0.3%, or less than 0.2% by weight based on the weight of the pesticide and/or composition.

The term “a” or “an” as used herein includes the singular and the plural, unless specifically stated otherwise. Therefore, the terms “a,” “an” or “at least one” can be used interchangeably in this application.

Throughout the application, descriptions of various embodiments use the term “comprising”; however, it will be understood by one of skill in the art, that in some specific instances, an embodiment can alternatively be described using the language “consisting essentially of” or “consisting of ”

The term “about” as used herein specifically includes ±10% from the indicated values in the range. In addition, the endpoints of all ranges directed to the same component or property herein are inclusive of the endpoints, are independently combinable, and include all intermediate points and ranges. It is understood that where a parameter range is provided, all integers within that range, and tenths thereof, are also provided by the invention. For example, “10-50%” includes 10%, 10.1%, 10.2%, etc. up to 50%.

### Agrochemical Composition

Efficiency of agrochemical is often reduced by limited uptake, penetration, and/or bioavailability of the active component.

Leaf cuticles are coated with a protective film that is highly hydrophobic. Cyclodextrins, like water, are very polar compounds and are expected to be rejected from the leaf surface and to have less effect on the tension of the leaf surface.

Surprisingly, it was found that cyclodextrins affect the biological activity of pesticides on the pest directly and indirectly. Cyclodextrin affect interaction of the pesticide with the leaf surface and enhance the biological activity of the pesticide. It was found that by chemically interacting a pesticide with cyclodextrins to form inclusion complexes and/or by encapsulating the pesticide molecule within the cyclodextrin molecular matrix, the biological activity of the pesticide is increased. The biological activity of cyclodextrin compositions comprising the chemically interacted pesticide guest/host molecular structure is much more pronounced and significant than compositions of the same pesticide using surfactants, organic solvents, suspending agents or other adjuvants.

Cyclodextrins are known as dissolving agents which enhance the solubility of lipophilic compounds in water. However, it was found that increasing only the solubility of a pesticide does not improve its biological activity.

Cyclodextrin are inactive ingredients but were found to affects the biological activity of the guest pesticide when chemically interacted with the guest pesticide by forming inclusion complexation or encapsulating the guest pesticide within the host cyclodextrin molecular structure. The advantage of the present invention is that the carrier is water and not organic solvents which may be toxic to humans and the environment. In addition, there is no need for an additional adjuvant or other additives for increasing the activity of the pesticide. Furthermore, as a composition, the physical and chemical properties of the active agent are not greatly affected, and the composition can be easily controlled.Cyclodextrins are known to have different uses in the pharmaceutical, food and agriculture industries; however, the improvement of biological activity by enhancing retention and/or bioavailability of the pesticide is new and opens a whole new approach for pest control.

Cyclodextrins, in addition to increasing solubility and reducing volatility, were found to enhance bioavailability, retention and/or efficacy of the pesticide.

The present invention provides a composition comprising an effective amount of at least one pesticide and cyclodextrin, wherein the pesticide molecules interact with the cyclodextrin molecular matrix through intermolecular force(s).

In some embodiments, the pesticide molecules interact chemically with the cyclodextrin molecular matrix through intermolecular force(s).

The present invention provides a composition comprising an effective amount of at least one pesticide and cyclodextrin, wherein the pesticide molecules interact chemically with the cyclodextrin molecular matrix through intermolecular force(s).

In some embodiments, the pesticide is a fungicide. In some embodiments, the pesticide is an insecticide. In some embodiments, the pesticide is an herbicide.

In some embodiments, the fungicide is a triazole fungicide.

In some embodiments, the insecticide is a pyrethroid insecticide.

The present invention provides a composition comprising an effective amount of a pesticide and cyclodextrin, wherein the pesticide molecules interact chemically with the cyclodextrin molecular matrix through intermolecular force(s) and wherein the pesticide is selected from triazole fungicide and pyrethroid insecticide.

The present invention provides a composition comprising an effective amount of at least one triazole fungicide and cyclodextrin, wherein the triazole fungicide molecules interact with the cyclodextrin molecular matrix through intermolecular force(s).

The present invention provides a composition comprising an effective amount of at least one pyrethroid insecticide and cyclodextrin, wherein the pyrethroid insecticide molecules interact with the cyclodextrin molecular matrix through intermolecular force(s).

The present invention provides a fungicidal composition comprising (i) an effective amount of at least one triazole fungicide; (ii) cyclodextrin and (iii) an agriculturally acceptable carrier, wherein the triazole fungicide molecules interact with the cyclodextrin molecular matrix through intermolecular force(s).

The present invention provides an insecticidal composition comprising (i) an effective amount of at least one pyrethroid insecticide; (ii) cyclodextrin and (iii) an agriculturally acceptable carrier, wherein the pyrethroid insecticide molecules interact with the cyclodextrin molecular matrix through intermolecular force(s).

The present invention provides a composition comprising an effective amount of at least one triazole fungicide and cyclodextrin, wherein the triazole fungicide molecules interact chemically with the cyclodextrin molecular matrix through intermolecular force(s).

The present invention provides a composition comprising an effective amount of at least one pyrethroid insecticide and cyclodextrin, wherein the pyrethroid insecticide molecules interact chemically with the cyclodextrin molecular matrix through intermolecular force(s).

The present invention provides a fungicidal composition comprising (i) an effective amount of at least one triazole fungicide; (ii) cyclodextrin and (iii) an agriculturally acceptable carrier, wherein the triazole fungicide molecules interact chemically with the cyclodextrin molecular matrix through intermolecular force(s).

The present invention provides an insecticidal composition comprising (i) an effective amount of at least one pyrethroid insecticide; (ii) cyclodextrin and (iii) an agriculturally acceptable carrier, wherein the pyrethroid insecticide molecules interact chemically with the cyclodextrin molecular matrix through intermolecular force(s).

In some embodiments, the triazole fungicide may include but is not limited to prothioconazole, epoxiconazole, cyproconazole, myclobutanil, metconazole, difenoconazole, tebuconazole, tetraconazole, fenbuconazole, propiconazole, fluquinconazole, flusilazole, flutriafol, triadimefon, triadimenol, triticonazole; uniconazole, simeconazole, hexaconazole, imibenconazole, bitertanol; bromuconazole, ipconazole, itraconazole, paclobutrazol, penconazole, diniconazole and diniconazole-M.

In some embodiments, the triazole fungicide is prothioconazole.

In some embodiments, the triazole fungicide is epoxiconazole.

In some embodiments, the triazole fungicide is propiconazole.

In some embodiments, the pyrethroid insecticide may include but is not limited to acrinathrin, allethrin (d-cis-trans, d-trans), beta-cyfluthrin, bifenthrin, bioallethrin, bioallethrin-S-cyclopentyl-isomer, bioethanomethrin, biopermethrin, bioresmethrin, chlovaporthrin, cis-cypermethrin, cis-resmethrin, cis-permethrin, clocythrin, cycloprothrin, cyflu-thrin, cyhalothrin, cypermethrin (alpha-, beta-, theta-, zeta-), cyphenothrin, DDT, deltamethrin, empenthrin (1R isomer), esfenvalerate, etofenprox, fenfluthrin, fenpropathrin, fenpyrithrin, fen-valerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans isomer), prallethrin, profluthrin, protrifenbute, pyresmethrin, resmethrin, RU 15525, silafluofen, tau-fluvalinate, tefluthrin, terallethrin, tetramethrin (1R-isomer), tralomethrin, transfluthrin, ZXI 8901, pyrethrins (pyrethrum)) oxadiazines (for example indoxacarb).

In some embodiments, the pyrethroid insecticide is tau-fluvalinate.

In some embodiments, the pyrethroid insecticide is bifenthrin.

In some embodiments, the pyrethroid insecticide is deltamithrin.

The present invention provides a fungicidal composition comprising (i) an effective amount of prothioconazole; (ii) cyclodextrin and (iii) an agriculturally acceptable carrier, wherein the prothioconazole molecules interact with the cyclodextrin molecular matrix through intermolecular force(s).

The present invention provides a fungicidal composition comprising (i) an effective amount of epoxiconazole; (ii) cyclodextrin and (iii) an agriculturally acceptable carrier, wherein the epoxiconazole molecules interact with the cyclodextrin molecular matrix through intermolecular force(s).

The present invention provides a fungicidal composition comprising (i) an effective amount of propiconazole; (ii) cyclodextrin and (iii) an agriculturally acceptable carrier, wherein the propiconazole molecules interact with the cyclodextrin molecular matrix through intermolecular force(s).

The present invention provides an insecticidal composition comprising (i) an effective amount of tau-fluvalinate; (ii) cyclodextrin and (iii) an agriculturally acceptable carrier, wherein the tau-fluvalinate molecules interact with the cyclodextrin molecular matrix through intermolecular force(s).

The present invention provides an insecticidal composition comprising (i) an effective amount of bifenthrin; (ii) cyclodextrin and (iii) an agriculturally acceptable carrier, wherein the bifenthrin molecules interact with the cyclodextrin molecular matrix through intermolecular force(s).

The present invention provides an insecticidal composition comprising (i) an effective amount of deltamithrin; (ii) cyclodextrin and (iii) an agriculturally acceptable carrier, wherein the deltamithrin molecules interact with the cyclodextrin molecular matrix through intermolecular force(s).

The present invention provides a fungicidal composition comprising (i) an effective amount of prothioconazole; (ii) cyclodextrin and (iii) an agriculturally acceptable carrier, wherein the prothioconazole molecules interact chemically with the cyclodextrin molecular matrix through intermolecular force(s).

The present invention provides a fungicidal composition comprising (i) an effective amount of epoxiconazole; (ii) cyclodextrin and (iii) an agriculturally acceptable carrier, wherein the epoxiconazole molecules interact chemically with the cyclodextrin molecular matrix through intermolecular force(s).

The present invention provides a fungicidal composition comprising (i) an effective amount of propiconazole; (ii) cyclodextrin and (iii) an agriculturally acceptable carrier, wherein the propiconazole molecules interact chemically with the cyclodextrin molecular matrix through intermolecular force(s).

The present invention provides an insecticidal composition comprising (i) an effective amount of tau-fluvalinate; (ii) cyclodextrin and (iii) an agriculturally acceptable carrier, wherein the tau-fluvalinate molecules interact chemically with the cyclodextrin molecular matrix through intermolecular force(s).

The present invention provides an insecticidal composition comprising (i) an effective amount of bifenthrin; (ii) cyclodextrin and (iii) an agriculturally acceptable carrier, wherein the bifenthrin molecules interact chemically with the cyclodextrin molecular matrix through intermolecular force(s).

The present invention provides an insecticidal composition comprising (i) an effective amount of deltamithrin; (ii) cyclodextrin and (iii) an agriculturally acceptable carrier, wherein the deltamithrin molecules interact chemically with the cyclodextrin molecular matrix through intermolecular force(s).

In some embodiments, the pesticide molecules are complexed with the cyclodextrin molecular matrix. In some embodiments, the pesticide molecules are encapsulated within the cyclodextrin molecular matrix.

In some embodiments, the insecticide molecules are complexed with the cyclodextrin molecular matrix. In some embodiments, the insecticide molecules are encapsulated within the cyclodextrin molecular matrix.

In some embodiments, the fungicide molecules are complexed with the cyclodextrin molecular matrix. In some embodiments, the fungicide molecules are encapsulated within the cyclodextrin molecular matrix.

In aqueous solutions, guest/host inclusion cyclodextrin complexes and molecular encapsulation structures may both be present. This inclusion complex behaves just as the free, dissolved molecule, due to its very dynamic dissociation equilibrium. When dispersing cyclodextrin complexes in water, the chemical composition of the formed guest/host matrix system will depend upon the physical and chemical properties of both the guest pesticide and host cyclodextrin matrix complex.

In some embodiments, the pesticide molecules are encapsulated within or complexed with the cyclodextrin molecular matrix by melting-in process. In some embodiments, the pesticide molecules are encapsulated within or complexed with the cyclodextrin molecular matrix by preparing a physical powder mixture blend. In some embodiments, the pesticide molecules are encapsulated within or complexed with the cyclodextrin molecular matrix by co-precipitation process.

In some embodiments, the insecticide molecules are encapsulated within or complexed with the cyclodextrin molecular matrix by melting-in process. In some embodiments, the insecticide molecules are encapsulated within or complexed with the cyclodextrin molecular matrix by preparing a physical powder mixture blend. In some embodiments, the insecticide molecules are encapsulated within or complexed with the cyclodextrin molecular matrix by co-precipitation process.

In some embodiments, the fungicide molecules are encapsulated within or complexed with the cyclodextrin molecular complex by melting-in process. In some embodiments, the fungicide molecules are encapsulated within or complexed with the cyclodextrin molecualar matrix by preparing a physical powder mixture blend. In some embodiments, the fungicide molecules are encapsulated within or complexed with the cyclodextrin molecular matrix by co-precipitation process.

In some embodiments, the agriculturally acceptable carrier is water.

In some embodiments, the composition is substantially free of an agriculturally acceptable organic solvent.

In some embodiments, the composition is substantially free of an agriculturally acceptable additive.

In some embodiments, the composition is substantially free of any adjuvant. In some embodiments, the composition is free of any adjuvant.

In some embodiments, the cyclodextrin is α (alpha)-cyclodextrin: 6-membered sugar ring molecule. In some embodiments, the cyclodextrin is β (beta)-cyclodextrin: 7-membered sugar ring molecule. In some embodiments, the cyclodextrin is γ (gamma)-cyclodextrin: 8-membered sugar ring molecule.

In some embodiments, the cyclodextrin is alkylated. In some embodiments, the cyclodextrin is alkylated with C₁-C₅ alkyl group. In some embodiments, the cyclodextrin is methylated. In some embodiments, the alkyl group is substituted with hydroxyl group.

Cyclodextrin includes methyl derivatives of cyclodextrin and hydroxypropyl derivatives of cyclodextrin.

In some embodiments, the cyclodextrin is a methyl-beta-cyclodextrin. In some embodiments, the cyclodextrin is a hydroxypropyl-beta-cyclodextrin. In some embodiments, the cyclodextrin is a hydroxypropyl-gamma-cyclodextrin.

Suitable cyclodextrins that may be used in connection with the subject invention include but are not limited to Cavamax™ W7 (beta-cyclodextrin), Cavamax™ W8 (gamma-cyclodextrin), Cavasol™ W7M (methyl-beta-cyclodextrin), Cavasol™ W7HP (hydroxypropyl-beta-cyclodextrin), and Cavasol™ W8HP (hydroxypropyl-gamma-cyclodextrin) manufactured by Wacker Chemie AG.

The size of the cyclodextrin which is used in the present invention correlates with the size and structure of the agrochemical, for example, the pesticide.

In some embodiments, the cyclodextrin has the following structure:

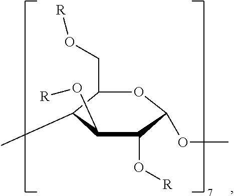

wherein R is H or methyl.

In some embodiments, the cyclodextrin has the following structure:

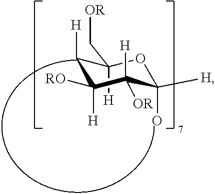

wherein R is

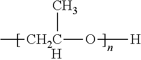

and n is an integer equal to or greater than 0.

In some embodiments, the pesticide molecules are complexed with or encapsulated within the cyclodextrin molecular matrix. In some embodiments, the fungicide or insecticide molecules are complexed with or encapsulated within the cyclodextrin molecular matrix.

In some embodiments, the composition comprises at least one type of cyclodextrin. In some embodiments, the composition comprises at least two types of cyclodextrins.

In some embodiments, the composition is substantially free of an adjuvant.

In some embodiments, the cyclodextrin acts as a built-in adjuvant for the pesticide. In some embodiments, the cyclodextrin acts as a built-in adjuvant for the fungicide or insecticide.

In some embodiments, the concentration of cyclodextrin in the composition is between 0.1 to 20 g/kg. In some embodiments, the concentration of cyclodextrin in the composition is between 0.1 to 5 g/kg. In some embodiments, the concentration of cyclodextrin in the composition is between 5 to 10 g/kg. In some embodiments, the concentration of cyclodextrin in the composition is between 10 to 15 g/kg. In some embodiments, the concentration of cyclodextrin in the composition is between 15 to 20 g/kg.

In some embodiments, the concentration of the pesticide in the composition is between 0.1 to 20 g/kg. In some embodiments, the concentration of the pesticide in the composition is between 0.1 to 5 g/kg. In some embodiments, the concentration of the pesticide in the composition is between 5 to 10 g/kg. In some embodiments, the concentration of the pesticide in the composition is between 10 to 15 g/kg. In some embodiments, the concentration of the pesticide in the composition is between 15 to 20 g/kg.

In some embodiments, the concentration of the pesticide in the composition is 10-50% by weight based on the total weight of the composition. In some embodiments, the concentration of the pesticide in the composition is 10-20% by weight based on the total weight of the composition. In some embodiments, the concentration of the the pesticide in the composition is 20-30% by weight based on the total weight of the composition. In some embodiments, the concentration of the pesticide in the composition is 30-40% by weight based on the total weight of the composition. In some embodiments, the concentration of the pesticide in the composition is 40-50% by weight based on the total weight of the composition.

In some embodiments, the concentration of the cyclodextrin in the composition is 10-90% by weight based on the total weight of the composition. In some embodiments, the concentration of the cyclodextrin in the composition is 10-50% by weight based on the total weight of the composition. In some embodiments, the concentration of the cyclodextrin in the composition is 10-25% by weight based on the total weight of the composition. In some embodiments, the concentration of the cyclodextrin in the composition is 25-50% by weight based on the total weight of the composition. In some embodiments, the concentration of the cyclodextrin in the composition is 50-90% by weight based on the total weight of the composition. In some embodiments, the concentration of the cyclodextrin in the composition is 50-75% by weight based on the total weight of the composition. In some embodiments, the concentration of the cyclodextrin in the composition is 75-90% by weight based on the total weight of the composition.

In some embodiments, the composition is a stable composition.

In some embodiments, the molar ratio between the pesticide and the cyclodextrin is 1:1 to 1:10. In some embodiments, the molar ratio between the pesticide and the cyclodextrin is 1:5 to 1:4. In some embodiments, the molar ratio between the pesticide and the cyclodextrin is 1:5 to 1:3. In some embodiments, the molar ratio between the pesticide and the cyclodextrin is 1:5. In some embodiments, the molar ratio between the pesticide and the cyclodextrin is 1:3. In some embodiments, the molar ratio between the pesticide and the cyclodextrin is 1:2.

In some embodiments, the weight ratio between the pesticide and the cyclodextrin is 1:1 to 1:10. In some embodiments, the weight ratio between the pesticide and the cyclodextrin is 1:1 to 1:7. In some embodiments, the weight ratio between the pesticide and the cyclodextrin is 1:5 to 1:1. In some embodiments, the weight ratio between the pesticide and the cyclodextrin is 1:5 to 1:4. In some embodiments, the weight ratio between the pesticide and the cyclodextrin is 1:5 to 1:3. In some embodiments, the weight ratio between the pesticide and the cyclodextrin is 1:5. In some embodiments, the weight ratio between the pesticide and the cyclodextrin is 1:3. In some embodiments, the weight ratio between the pesticide and the cyclodextrin is 1:2.

The partition coefficient (logP) and dissociation constant (pKa) of a pesticide active ingredient are known to be determinants of pesticide mobility in plants. The logP of a given molecule describes its lipophilicity or hydrophilicity, where lipophilicity describes a molecule's ability to dissolve in lipophilic (non-aqueous) solutions, allowing permeation through biological membranes. The pKa value of a given molecule defines the pH at which it is neutral. At greater pH values, acid groups will be charged, while at lower pH values base groups will be charged. The number and distribution of charges on a molecule affect its aqueous solubility. It is well accepted that the solubility of the active ingredient is thus determined by its lipophilicity and dissociation constant, and an understanding of these physicochemical properties is a vital component of pesticide composition development.

Lipophilic active ingredient molecules may resist solubility in water the most common medium for agricultural sprays and typically require composition with organic solvents or oils. In contrast, hydrophilic active ingredient molecules are easily solubilized in aqueous spray solutions, while the uptake of these molecules across lipophilic plant leaf barriers often requires the inclusion of surfactants in the final product. Delay or insufficient uptake of the active ingredient may lead to reduced efficacy, wash-off of the active ingredient by rain or UV-degradation of the unprotected molecules.

### Permeability, Uptake, Translocation, Polar Surface Area and Lipophilicity

The polar surface area (PSA) of a molecule is defined as the surface area occupied by oxygen and nitrogen atoms, and hydrogen atoms bound to these heteroatoms. The transport process across lipid barriers, according to the solubility/diffusion model and the pH-partitioning theory, is dependent on three properties: i) the partitioning between membrane and water; ii) the charge; and iii) the size of the solute (since the diffusion rate in the membrane is assumed to be dependent on the size of the solute).

Membrane partitioning has been considered as a two-step process and this model has been applied successfully to describe passive transport of active compounds across cell membranes and lipid barriers. The application of a two-step partitioning process can be motivated if we consider the insertion of a polar, but lipophilic, molecule into a lipid membrane. In the first step, lipophilicity is the major driving force for drug incorporation into the lipid bilayer. By contrast, in the second step, in which the drug is transferred into the interior of the lipid bilayer, the interactions between the bilayer and the polar parts of the solute are more important than is the lipophilicity and can be largely accounted for by hydrogen bonding and polarity.

With the two-step partitioning process, the PSA, which is generally assumed to be related to hydrogen bonding capacity, is particularly considered as good predictor of passive membrane permeability. Indeed, a search of the literature showed that this factor had already been introduced as a descriptor for blood-brain partitioning of active substances. Active ingredients that are transported passively by transcellular route should not display a PSA >120A². Active ingredients that are completely absorbed through lipophilic barriers/membranes should have a PSA <60-70A² (Kelder et al, Pharm. res., 16, 1514-1519, 1999).

PSA can be used as a predictor of membrane permeability also in tissues other than the intestinal epithelium. A similar conclusion was reached by Clark, who derived a simple quantitative structure-activity relationship (QSAR) model for brain penetration from a combination of PSA and log P. PSA has been combined with other predictive molecular descriptors such as calculated log P and the number of rotatable bonds, or been included in rule-based systems such as the Lipinski's rule of five, with good results. Thus, brain penetration is predicted for actice compounds with high log P and low PSA [Clark, J. Pharmac. Sci., 88, 807, 1999].

The study of the transport of organic compounds through biological barriers has also been investigated in plant systems. Plant uptake was described using the transpiration stream concentration factor (TSCF), a ratio of chemical concentration in the xylem pore water to the chemical concentration in the feed solution. Typically, models relate the TSCF to hydrophobilicy [i.e., octanol-water partitioning (logP)], generally demonstrating bell-shaped curves, where moderately hydrophobic compounds (log P values of 1-3) show the greatest levels of uptake. Additionally, moderately hydrophobic compounds are most likely to be translocated by plants with most translocatable compounds exhibiting a log P between 1 and 4, translocatable compounds generally having a molecular mass of <350 Da, hydrogen bond donor and acceptor appear to have cutoffs around 4 and 7 respectively and rotatable bond cutoff of 7. The PSA cutoff for plant-translocatable compounds is ˜90A2 [Limmer et al, Environ. Sci. Technol. Lett. 2014, 1, 156-161, 2014].

In some embodiments, the pesticide in the present invention has a log P value between 1 to 7.

In some embodiments, the presently described compositions may further comprise one or more additional agrochemicals.

Various agrochemicals may be used. Exemplary among such agrochemicals without limitation are crop protection agents, for example pesticides, safeners, plant growth regulators, repellents, bio stimulants or such preservatives as bacteriostats or bactericides.

Pesticide include but are not limited to herbicide, insecticide, fungicide, nematocide, mollusks repellent and control agent.

In some embodiments, the fungicide is a succinate dehydrogenase inhibitor.

In some embodiments, the succinate dehydrogenase inhibitor is selected from the group consisting of fluxapyroxad, benzovindiflupyr, penthiopyrad, isopyrazam, bixafen, boscalid, penflufen, and fluopyram.

In some embodiments, the fungicide is a strobilurin fungicide.

In some embodiments, the strobilurin fungicide is selected from the group consisting of pyraclostrobin, fluoxastrobin, azoxystrobin, trifloxystrobin, picoxystrobin, and kresoxim-methyl.

In some embodiments, the fungicidal is a multisite inhibitor.

In some embodiments, the fungicidal multisite inhibitor is selected from a group consisting of chlorothalonil, mancozeb, folpet, and captan.

In some embodiments, the fungicide is selected from the group consisting of: 5-fluoro-4-imino-3-methyl-1-tosyl-3 ,4-dihydropyrimidin-2 (1H)-one, fluxapyroxad, 2-pheny 1phenol; 8-hydroxyquinoline sulphate; acibenzolar-S-methyl; imibenconazole; fluquinconazole aldimorph; amidoflumet; ampropylfos; ampropylfos-potassium; andoprim; anilazine; azaconazole; azoxystrobin; benalaxyl; benalaxyl-M; benodanil; benomyl; benthiavalicarb-isopropyl; benzamacril; benzamacril-isobutyl; bilanafos; bina-pacryl; biphenyl; bitertanol; itraconazole; blasticidin-S; boscalid;bromuconazole; bupirimate; buthiobate; butylamine; calcium polysulphide; capsimycin; captafol; captan; carbendazim; carboxin; carpropamid; carvone; quinomethionate; chlobenthiazone;chlorfenazole; chloroneb; chlorothalonil; chlozolinate; clozylacon; cyazofamid; cyflufenamid; cymoxanil;cyproconazole; cyprodinil; cyprofuram; Dagger G; debacarb; dichlofluanid; dichlone; dichlorophen; diclocymet; diclomezine; dicloran; diethofencarb;difenoconazole; diflumetorim; dimethirimol; dimethomorph; dimoxystrobin; diniconazole; diniconazole-M; dinocap; diphenylamine; dipyrithione; ditalimfos; dithianon; dodine; drazoxolon; edifenphos; epoxiconazole; ethaboxam; ethirimol;etridiazole; famoxadone; fenamidone; fenapanil; fenarimol;fenbuconazole; fenfuram; fenhexamid; fenitropan; fenoxanil; fenpiclonil; fenpropidin; fenpropimorph; ferbam; fluazinam; flubenzimine; fludioxonil; flumetover; flumorph; fluoromide; fluoxastrobin; flurprimidol; flusilazole; flusulfamide; flutolanil;flutriafol; prothioconazole; folpet; fosetyl-A1; fosetyl-sodium; fuberidazole; furalaxyl; furametpyr; furcarbanil; furmecyclox; guazatine; hexachlorobenzene; hexaconazole; hymexazol; imazalil; iminoctadine tri acetate; iminoctadine tris(albesilate); iodocarb;ipconazole; iprobenfos; iprodione; iprovalicarb; irumamycin; isoprothiolane; isovaledione; kasugamycin; kresoxim-methyl; mancozeb; maneb; meferimzone; mepanipyrim; mepronil; metalaxyl; metalaxyl-M;metconazole; methasulfocarb; methfuroxam; metiram; metominostrobin; metsulfovax; mildiomycin; myclobutanil; myclozolin; natamycin; nicobifen; nitrothal-isopropyl; noviflumuron; nuarimol; ofurace; orysastrobin; oxadixyl; oxolinic acid;oxpoconazole; oxy carboxin; oxyfenthiin;paclobutrazol; pefurazoate;penconazole; pencycuron; phosdiphen; phthalide; picoxystrobin; piperalin; polyoxins; polyoxorim;probenazole; prochloraz; procymidone; propamocarb; propanosine-sodium; propiconazole;, propineb; proquinazid;prothioconazole; pyraclostrobin; pyrazophos; pyrifenox; pyrimethanil; pyroquilon; pyroxyfur; pyrrolnitrine; quinconazole; quinoxyfen; quintozene; silthiofam; simeconazole; spiroxamine; sulfur;tebuconazole; tecloftalam; tecnazene; tetcy clacis;tetraconazole; thiabendazole; thicy ofen; thifluzamide; thiophanate-methyl; thiram; tioxymid; tolclofos-methyl; tolylfluanid;triadimefon; triadimenol; triazbutil; triazoxide; tricyclamide; tricyclazole; tridemorph; trifloxystrobin; triflumizole; triforine; triticonazole; uniconazole; validamycin A; vinclozolin; zineb; ziram; zoxamide; (2S)-N-[2-[4-[[3-(4-chlorophenyl)-2-propynyl]oxy]-3-methoxy-phenyl]ethyl]-3-methyl-2-[(methylsulfonyl)amino] butanamide; 1-(1-naphthalenyl)-1H-pyrrol e-2,5-di one; 2,3,5,6-tetrachloro-4-(methylsulfonyl)py ridine; 2-amino-4-methyl-N-phenyl-5-thi azolecarb oxamide; 2-chloro-N-(2,3-dihydro-1,1,3-trimethyl-1H-inden-4-yl)-3-pyridinecarboxamide; 3,4,5-trichloro-2,6-pyridinedicarbonitrile; actinovate; cis-1-(4-chlorophenyl)2-1H-1,2,4-triazol-1-yl)cycloheptanol; methyl 1-(2,3-dihydro-2,2-dimethyl-1H-inden-1-yl)-1H-imidazole-5-carboxylate; monopotassium carbonate; N-6-methoxy-3-pyridinyl)cyclopropanecarboxamide; N-butyl-8-(1,1-dimethylethyl)-1-oxa-spiro[4,5]decan-3-amine; sodium tetracarbonate; N-3′4′-di chloro-5-fluorobiphenyl-2-yl)-3-(difluoromethyl)-1-methyl-1H-pyrazole-4-carboxamide; and copper salts and preparations, such as Bordeaux mixture; copper hydroxide, copper naphthenate; copper oxychloride; copper sulphate; cufraneb; cuprous oxide; mancopper; oxine copper. Bactericides: bronopol, dichlorophen, nitrapyrin, nickel-dimethyldithiocarbamate, kasugamycin, octhilinone, furancarboxylic acid, oxytetracyclin, streptomycin, tecloftalam, copper sulphate and other copper preparations.

In some embodiments, the agrochemical is an insecticide.

In some embodiments, insecticide is an acetylcholinesterase (AChE) inhibitors carbamates (for example alanycarb, aldicarb, aldoxycarb, allyxycarb, aminocarb, azamethiphos, bendiocarb, benfuracarb, bufencarb, butacarb, butocarboxim, butoxycarboxim, carbaryl, carbofuran, carbosulfan, chloethocarb, coumaphos, cyanofenphos, cyanophos, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, triazamate, trimethacarb, XMC, xylylcarb) organophosphates (for example acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-S -methyl, demeton-S-methyl sulphone, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion).

In some embodiments, the insecticide is a sodium channel modulators/voltage-dependent sodium channel blockers pyrethroids (for example acrinathrin, allethrin (d-cis-trans, d-trans), beta-cyfluthrin, bifenthrin, bioallethrin, bioallethrin-S-cyclopentyl-isomer, bioethanomethrin, biopermethrin, bioresmethrin, chlovaporthrin, cis-cypermethrin, cis-resmethrin, cis-permethrin, clocythrin, cycloprothrin, cyflu-thrin, cyhalothrin, cypermethrin (alpha-, beta-, theta-, zeta-), cyphenothrin, DDT, deltamethrin, empenthrin (1R isomer), esfenvalerate, etofenprox, fenfluthrin, fenpropathrin, fenpyrithrin, fen-valerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans isomer), prallethrin, profluthrin, protrifenbute, pyresmethrin, resmethrin, RU 15525, silafluofen, tau-fluvalinate, tefluthrin, terallethrin, tetramethrin (1R-isomer), tralomethrin, transfluthrin, ZXI 8901, pyrethrins (pyrethrum)) oxadiazines (for example indoxacarb).

In some embodiments, the insecticide is an acetylcholine receptor agonists/antagonists, chloronicotinyls/neonicotinoids (for example acetamiprid, clothianidin, dinotefuran, imidacloprid, nitenpyram, nithiazine, thiacloprid, thiamethoxam), and nicotine, bensultap, cartap.

In some embodiments, the insecticide is an acetylcholine receptor modulators such as spinosyns (for example spinosad).

In some embodiments, the insecticide is a GABA-controlled chloride channel antagonists, cyclodiene organochlorines (for example camphechlor, chlordane, endosulfan, gamma-HCH, HCH, heptachlor, lindane, methoxychlor), fiprols (for example acetoprole, ethiprole, fipronil, vaniliprole).

In some embodiments, the insecticide is a chloride channel activators, mectins (for example abamectin, avermectin, emamectin, emamectin-benzoate, ivermectin, milbemectin, milbemycin).

In some embodiments, the insecticide is a Juvenile Hormone Mimetics (for example diofenolan, epofenonane, fenoxycarb, hydroprene, kinoprene, methoprene, pyriproxifen, triprene).

In some embodiments, the insecticide is an ecdysone Agonists/Disruptors, diacylhydrazines (for example chromafenozide, halofenozide, methoxyfenozide, tebufenozide)

In some embodiments, the insecticide is a chitin biosynthesis inhibitor, benzoylureas (for example bistrifluoron, chlofluazuron, diflubenzuron, fluazuron, flucycloxuron, flufenoxuron, hexaflumuron, lufenuron, novaluron, noviflumuron, penfluoron, teflubenzuron, triflumuron), buprofezin, cyromazine

In some embodiments, the insecticide is an Inhibitors of oxidative phosphorylation, ATP disruptors, diafenthiuron, organotin compounds (for example azocyclotin, cyhexatin, fenbutatin-oxide)

In some embodiments, the insecticide is a pyrrole-based uncoupler of oxidative phosphorylation by interrupting the H proton gradient, (for example chlorfenapyr) dinitrophenols (for example binapacyri, dinobuton, dinocap, DNOC)

In some embodiments, the insecticide is a Site-I electron transport inhibitor, METIs (for example fenazaquin, fenpyroximate, pyrimidifen, pyridaben, tebufenpyrad, tolfenpyrad) hydramethylnon, dicofol

In some embodiments, the insecticide is rotenone, a Site-II electron transport inhibitor,

In some embodiments, the insecticide is a Site-III electron transport inhibitors, such as acequinocyl, fluacrypyrim

In some embodiments, the insecticide is a microbial disruptor of the insect gut membrane Bacillus thuringiensis strains.

In some embodiments, the insecticide is a Fat Synthesis Inhibitor, such as tetronic acids (for example spirodiclofen, spiromesifen) tetramic acids [for example 3-(2,5-dimethylphenyl)-8-methoxy-2-oxo-1-azaspiro[4,5]dec-3-en-4-yl ethyl carbonate (also known as: carbonic acid, 3-(2,5-dimethylphenyl)-8-methoxy-2-oxo-1-azaspiro[4,5]dec-3-en-4-yl ethyl ester, CAS-Reg. No.: 382608-10-8) and carbonic acid, cis-3-(2,5-dimethylphenyl)-8-methoxy-2-oxo-1-azaspiro[4.5]dec-3-en-4-yl ethyl ester (CAS-Reg. No.: 203313-25-1)]

In some embodiments, the insecticide is a carboxamide. In some embodiments, the carboxamide is flonicamid.

In some embodiments, the insecticide is an octopaminergic agonist. In some embodiments, the octopaminergic agonist is amitraz.

In some embodiments, the insecticide is an inhibitor of magnesium-stimulated ATPase. In some embodiments, the inhibitor of magnesium-stimulated ATPase is propargite.

In some embodiments, the insecticide is a phthalamide (for example N<2>-[1,1-dimethyl-2-(methylsul phonyl)pethyl]-3-iodo-N<1>-[2-methyl-4-[1,2,2,2-tetrafluoro-1(trifluoromethyl)ethyl]phenyl]-1,2-benzenedicarboxamide (CAS-Reg. No.: 272451-65-7), flubendiamide)

In some embodiments, the insecticide is a nereistoxin analogue. In some embodiments, the nereistoxin analogue is thiocyclam hydrogen oxalate or thiosultap-sodium.

In some embodiments, the insecticide is a biological, hormone or pheromone. (for example azadirachtin, Bacillus spec., Beauveria spec., codlemone, Metarrhizium spec., Paecilomyces spec., thuringiensin, Verticillium spec.)

In some embodiments, the insecticide is an active compound with unknown or unspecific mechanisms of action, fumigants (for example aluminium phosphide, methyl bromide, sulphuryl fluoride) selective antifeedants (for example cryolite, flonicamid, pymetrozine) 23.3 mite growth inhibitors (for example clofentezine, etoxazole, hexythiazox) amidoflumet, benclothiaz, benzoximate, bifenazate, bromopropylate, buprofezin, quinomethionate, chlordimeform, chlorobenzilate, chloropicrin, clothiazoben, cycloprene, cyflu-metofen, dicyclanil, fenoxacrim, fentrifanil, flubenzimine, flufenerim, flutenzin, gossyplure, hydra-methylnone, japonilure, metoxadiazone, petroleum, piperonyl butoxide, potassium oleate, pyrafluprole, pyridalyl, pyriprole, sulfluramid, tetradifon, tetrasul, triarathene, verbutin.

In some embodiments, the agrochemical is an herbicide.

In some embodiments, the herbicide is an anilide such as, for example, diflufenican and propanil; arylcarboxylic acids such as, for example, dichloropicolinic acid, dicamba and picloram; aryloxyalkanoic acids such as, for example, 2,4-D, 2,4-DB, 2,4-DP, fluoroxypyr, MCPA, MCPP and triclopyr; aryloxyphenoxy-alkanoic esters, such as, for example, diclofop-methyl, fenoxaprop-ethyl, fluazifop-butyl, haloxyfop-methyl and quizalofop-ethyl; azinones, such as, for example, chloridazon and norflurazon; carbamates such as, for example, chlorpropham, desmedipham, phenmedipham and propham; chloroacetanilides such as, for example, alachlor, acetochlor, butachlor, metazachlor, metolachlor, pretilachlor and propachlor; dinitroanilines such as, for example, oryzalin, pendimethalin and trifluralin; diphenyl ethers such as, for example, acifluorfen, bifenox, fluoroglycofen, fomesafen, halosafen, lactofen and oxyfluorfen; ureas such as, for example, chlortoluron, diuron, fluometuron, isoproturon, linuron and methabenzthiazuron; hydroxylamines such as, for example, alloxydim, clethodim, cycloxydim, sethoxydim and tralkoxydim; imidazolinones such as, for example, imazethapyr, imazamethabenz, imazapyr and imazaquin; nitriles such as, for example, bromoxynil, dichlobenil and ioxynil; oxyacetamides such as, for example, mefenacet; sulphonylureas such as, for example, amidosulfuron, bensulfuron-methyl, chlorimuron-ethyl, chlorsulfuron, cinosulfuron, metsulfuron-methyl, nicosulfuron, primisulfuron, pyrazosulfuron-ethyl, thifensulfuron-methyl, triasulfuron and tribenuron-methyl; thiocarbamates such as, for example, butylate, cycloate, di-allate, EPTC, esprocarb, molinate, prosulfocarb, thio-bencarb and tri-allate; triazines such as, for example, atrazin, cyanazin, simazin, simetryne, terbutryne and terbutylazin; triazinones such as, for example, hexazinon, metamitron and metribuzin; others such as, for example, aminoazoleazole, 4-amino-N-(1,1-dimethylethyl)-4,5-dihydro-3-(1-methylethyl)-5-oxo-1H-1,2,4-azoleazole-1-carboxamide, benfuresate, bentazone, cinmethylin, clomazone, clopyralid, difenzoquat, dithiopyr, ethofumesate, fluorochloridone, glufosinate, glyphosate, isoxaben, pyridate, quinchlorac, quinmerac, sulphosate and tridiphane.

In some embodiments, the agrochemical is a control agent.

In some embodiments, the control agent is fluensulfone.

In some embodiments, the agrochemical is nematocide and/or mollusks repellent and the control agent is fluensulfone.

Examples of plant growth regulators which may be used are chlorcholin chloride, thidiazuron, cyclanilide, ethephon, benzyladenine and gibberellic acid.

Examples of the safener groups which may be mentioned are mefenpyr, isoxadifen and cloquintocet-mexyl.

Examples of repellents which may be mentioned are diethyltolylamide, ethylhexanediol and butopyronoxyl.

In some embodiments, the composition further comprises an additive.

Additives include physical stabilizer such as buffers, acidifiers, defoaming agents, thickeners and drift retardants.

Additives also include but are not limited to surfactants, pigments, wetting agents, as well as safeners, or such preservatives as bacteriostats or bactericides.

Surfactants may include nut are not limted to ionic or non-ionic surface active agents Examples of surfactants are alkyl-end-capped ethoxylate glycol, alkyl-end-capped alkyl block alkoxylate glycol, dialkyl sulfosuccinate, phosphated esters, alkyl sulfonates, alkyl aryl sulfonates, tristyrylphenol alkoxylates, natural or synthetic fatty acid alkoxylates, natural or synthetic fatty alcohols alkoxylates, alkoxylated alcohols (such as n-butyl alcohol poly glycol ether), block copolymers (such as ethylene oxide-propylene oxide block copolymers and ethylene oxide-butylene oxide block copolymers) or combinations thereof.

The agrochemical compositions according to the invention, for example in the dosage forms which are conventional for liquid preparations, can be applied either as such or after previously having been diluted with water, that is to say for example as emulsions, suspensions, dispersions or solutions. The application here is accomplished by the customary methods for example, by spraying, pouring or injecting.

The application rate of the agrochemical compositions according to the invention can be varied within a substantial range. It depends on the agrochemical active substance in question and on their content in the compositions.

The present invention provides a fungicidal composition comprising (i) an effective amount of prothioconazole; (ii) cyclodextrin and (iii) an agriculturally acceptable carrier, wherein the prothioconazole molecules interact with the cyclodextrin molecular matrix through intermolecular force(s).

The present invention provides a fungicidal composition comprising (i) an effective amount of epoxiconazole; (ii) cyclodextrin and (iii) an agriculturally acceptable carrier, wherein the epoxiconazole molecules interact with the cyclodextrin molecular matrix through intermolecular force(s).

The present invention provides a fungicidal composition comprising (i) an effective amount of propiconazole; (ii) cyclodextrin and (iii) an agriculturally acceptable carrier, wherein the propiconazole molecules interact with the cyclodextrin molecular matrix through intermolecular force(s).

The present invention provides a fungicidal composition comprising (i) an effective amount of prothioconazole; (ii) methyl-beta-cyclodextrin and (iii) an agriculturally acceptable carrier, wherein the prothioconazole molecules interact with the methyl-beta-cyclodextrin molecular matrix through intermolecular force(s).

The present invention provides a fungicidal composition comprising (i) an effective amount of prothioconazole; (ii) hydroxypropyl-beta-cyclodextrin and (iii) an agriculturally acceptable carrier, wherein the prothioconazole molecules interact with the hydroxypropyl-beta-cyclodextrin molecular matrix through intermolecular force(s).

The present invention provides a fungicidal composition comprising (i) an effective amount of prothioconazole; (ii) methyl-beta-cyclodextrin and (iii) an agriculturally acceptable carrier, wherein the prothioconazole molecules interact with the methyl-beta-cyclodextrin molecular matrix through intermolecular force(s) and the weight ratio of prothioconazole to methylated β-cyclodextrin is from 1:1 to 1:5

The present invention provides a fungicidal composition comprising (i) an effective amount of prothioconazole; (ii) methyl-beta-cyclodextrin and (iii) an agriculturally acceptable carrier, wherein the prothioconazole molecules interact with the methyl-beta-cyclodextrin molecular matrix through intermolecular force(s) and the weight ratio of prothioconazole to methylated β-cyclodextrin is 1:2.

The present invention provides a fungicidal composition comprising (i) an effective amount of prothioconazole; (ii) hydroxypropyl-beta-cyclodextrin and (iii) an agriculturally acceptable carrier, wherein the prothioconazole molecules interact with the hydroxypropyl-beta-cyclodextrin molecular matrix through intermolecular force(s) and the weight ratio of prothioconazole to hydroxypropyl-beta-cyclodextrin is from 1:1 to 1:5.

The present invention provides a fungicidal composition comprising (i) an effective amount of prothioconazole; (ii) hydroxypropyl-beta-cyclodextrin and (iii) an agriculturally acceptable carrier, wherein the prothioconazole molecules interact with the hydroxypropyl-beta-cyclodextrin molecular matrix through intermolecular force(s) and the weight ratio of prothioconazole to hydroxypropyl-beta-cyclodextrin is 1:2.

The present invention provides a fungicidal composition comprising (i) an effective amount of prothioconazole; (ii) hydroxypropyl-gamma-cyclodextrin and (iii) an agriculturally acceptable carrier, wherein the prothioconazole molecules interact with the hydroxypropyl-gamma-cyclodextrin molecular matrix through intermolecular force(s).

The present invention provides a fungicidal composition comprising (i) an effective amount of prothioconazole; (ii) hydroxypropyl-gamma-cyclodextrin and (iii) an agriculturally acceptable carrier, wherein the prothioconazole molecules interact with the hydroxypropyl-gamma-cyclodextrin molecular matrix through intermolecular force(s) and the weight ratio of prothioconazole to hydroxypropyl-gamma-cyclodextrin is from 1:1 to 1:5.

The present invention provides a fungicidal composition comprising (i) an effective amount of prothioconazole; (ii) hydroxypropyl-gamma-cyclodextrin and (iii) an agriculturally acceptable carrier, wherein the prothioconazole molecules interact with the hydroxypropyl-gamma-cyclodextrin molecular matrix through intermolecular force(s) and the weight ratio of prothioconazole to hydroxypropyl-gamma-cyclodextrin is 1:2.

The present invention provides an insecticidal composition comprising (i) an effective amount of tau-fluvalinate; (ii) cyclodextrin and (iii) an agriculturally acceptable carrier, wherein the tau-fluvalinate molecules interact with the cyclodextrin molecular matrix through intermolecular force(s).

The present invention provides an insecticidal composition comprising (i) an effective amount of bifenthrin; (ii) cyclodextrin and (iii) an agriculturally acceptable carrier, wherein the bifenthrin molecules interact with the cyclodextrin molecular matrix through intermolecular force(s).

The present invention provides an insecticidal composition comprising (i) an effective amount of deltamithrin; (ii) cyclodextrin and (iii) an agriculturally acceptable carrier, wherein the deltamithrin molecules interact with the cyclodextrin molecular matrix through intermolecular force(s).

The present invention provides an insecticidal composition comprising (i) an effective amount of tau-fluvalinate; (ii) methyl-beta-cyclodextrin and (iii) an agriculturally acceptable carrier, wherein the tau-fluvalinate molecules interact with the methyl-beta-cyclodextrin molecular matrix through intermolecular force(s).

The present invention provides an insecticidal composition comprising (i) an effective amount of tau-fluvalinate; (ii) methyl-beta-cyclodextrin and (iii) an agriculturally acceptable carrier, wherein the tau-fluvalinate molecules interact with the methyl-beta-cyclodextrin molecular matrix through intermolecular force(s) and the weight ratio of tau-fluvalinate to methyl-beta-cyclodextrin is from 1:1 to 1:5.

The present invention provides an insecticidal composition comprising (i) an effective amount of tau-fluvalinate; (ii) methyl-beta-cyclodextrin and (iii) an agriculturally acceptable carrier, wherein the tau-fluvalinate molecules interact with the methyl-beta-cyclodextrin molecular matrix through intermolecular force(s) and the weight ratio of tau-fluvalinate to methyl-beta-cyclodextrin is from 1:3 to 1:5.

The present invention provides an insecticidal composition comprising (i) an effective amount of tau-fluvalinate; (ii) methyl-beta-cyclodextrin and (iii) an agriculturally acceptable carrier, wherein the tau-fluvalinate molecules interact with the methyl-beta-cyclodextrin molecular matrix through intermolecular force(s) and the weight ratio of tau-fluvalinate to methyl-beta-cyclodextrin is 1:3.

The present invention provides an insecticidal composition comprising (i) an effective amount of tau-fluvalinate; (ii) methyl-beta-cyclodextrin and (iii) an agriculturally acceptable carrier, wherein the tau-fluvalinate molecules interact with the methyl-beta-cyclodextrin molecular matrix through intermolecular force(s) and the weight ratio of tau-fluvalinate to methyl-beta-cyclodextrin is 1:5.

The present invention provides a fungicidal composition comprising (i) an effective amount of prothioconazole; (ii) cyclodextrin and (iii) an agriculturally acceptable carrier, wherein the prothioconazole molecules interact chemically with the cyclodextrin molecular matrix through intermolecular force(s).

The present invention provides a fungicidal composition comprising (i) an effective amount of epoxiconazole; (ii) cyclodextrin and (iii) an agriculturally acceptable carrier, wherein the epoxiconazole molecules interact chemically with the cyclodextrin molecular matrix through intermolecular force(s).

The present invention provides a fungicidal composition comprising (i) an effective amount of propiconazole; (ii) cyclodextrin and (iii) an agriculturally acceptable carrier, wherein the propiconazole molecules interact chemically with the cyclodextrin molecular matrix through intermolecular force(s).

The present invention provides a fungicidal composition comprising (i) an effective amount of prothioconazole; (ii) methyl-beta-cyclodextrin and (iii) an agriculturally acceptable carrier, wherein the prothioconazole molecules interact chemically with the methyl-beta-cyclodextrin molecular matrix through intermolecular force(s).

The present invention provides a fungicidal composition comprising (i) an effective amount of prothioconazole; (ii) hydroxypropyl-beta-cyclodextrin and (iii) an agriculturally acceptable carrier, wherein the prothioconazole molecules interact chemically with the hydroxypropyl-beta-cyclodextrin molecular matrix through intermolecular force(s).

The present invention provides a fungicidal composition comprising (i) an effective amount of prothioconazole; (ii) methyl-beta-cyclodextrin and (iii) an agriculturally acceptable carrier, wherein the prothioconazole molecules interact chemically with the methyl-beta-cyclodextrin molecular matrix through intermolecular force(s) and the weight ratio of prothioconazole to methyl-beta-cyclodextrin is from 1:1 to 1:5.

The present invention provides a fungicidal composition comprising (i) an effective amount of prothioconazole; (ii) methyl-beta-cyclodextrin and (iii) an agriculturally acceptable carrier, wherein the prothioconazole molecules interact chemically with the methyl-beta-cyclodextrin molecular matrix through intermolecular force(s) and the weight ratio of prothioconazole to methyl-beta-cyclodextrin is 1:2.

The present invention provides a fungicidal composition comprising (i) an effective amount ofprothioconazole; (ii) hydroxypropyl-beta-cyclodextrin and (iii) an agriculturally acceptable carrier, wherein the prothioconazole molecules interact chemically with the hydroxypropyl-beta-cyclodextrin molecular matrix through intermolecular force(s) and the weight ratio of prothioconazole to hydroxypropyl-beta-cyclodextrin is from 1:1 to 1:5.

The present invention provides a fungicidal composition comprising (i) an effective amount of prothioconazole; (ii) hydroxypropyl-beta-cyclodextrin and (iii) an agriculturally acceptable carrier, wherein the prothioconazole molecules interact chemically with the hydroxypropyl-beta-cyclodextrin molecular matrix through intermolecular force(s) and the weight ratio of prothioconazole to hydroxypropyl-beta-cyclodextrin is 1:2.

The present invention provides a fungicidal composition comprising (i) an effective amount of prothioconazole; (ii) hydroxypropyl-gamma-cyclodextrin and (iii) an agriculturally acceptable carrier, wherein the prothioconazole molecules interact chemically with the hydroxypropyl-gamma-cyclodextrin molecular matrix through intermolecular force(s).

The present invention provides a fungicidal composition comprising (i) an effective amount of prothioconazole; (ii) hydroxypropyl-gamma-cyclodextrin and (iii) an agriculturally acceptable carrier, wherein the prothioconazole molecules interact chemically with the hydroxypropyl-gamma-cyclodextrin molecular matrix through intermolecular force(s) and the weight ratio of prothioconazole to hydroxypropyl-gamma-cyclodextrin is from 1:1 to 1:5.

The present invention provides a fungicidal composition comprising (i) an effective amount of prothioconazole; (ii) hydroxypropyl-gamma-cyclodextrin and (iii) an agriculturally acceptable carrier, wherein the prothioconazole molecules interact chemically with the hydroxypropyl-gamma-cyclodextrin molecular matrix through intermolecular force(s) and the weight ratio of prothioconazole to hydroxypropyl-gamma-cyclodextrin is 1:2.

The present invention provides an insecticidal composition comprising (i) an effective amount of tau-fluvalinate; (ii) cyclodextrin and (iii) an agriculturally acceptable carrier, wherein the tau-fluvalinate molecules interact chemically with the cyclodextrin molecular matrix through intermolecular force(s).

The present invention provides an insecticidal composition comprising (i) an effective amount of bifenthrin; (ii) cyclodextrin and (iii) an agriculturally acceptable carrier, wherein the bifenthrin molecules interact chemically with the cyclodextrin molecular matrix through intermolecular force(s).

The present invention provides an insecticidal composition comprising (i) an effective amount of deltamithrin; (ii) cyclodextrin and (iii) an agriculturally acceptable carrier, wherein the deltamithrin molecules interact chemically with the cyclodextrin molecular matrix through intermolecular force(s).

The present invention provides an insecticidal composition comprising (i) an effective amount of tau-fluvalinate; (ii) methyl-beta-cyclodextrin and (iii) an agriculturally acceptable carrier, wherein the tau-fluvalinate molecules interact chemically with the methyl-beta-cyclodextrin molecular matrix through intermolecular force(s).

The present invention provides an insecticidal composition comprising (i) an effective amount of tau-fluvalinate; (ii) methyl-beta-cyclodextrin and (iii) an agriculturally acceptable carrier, wherein the tau-fluvalinate molecules interact chemically with the methyl-beta-cyclodextrin molecular matrix through intermolecular force(s) and the weight ratio of tau-fluvalinate to methyl-beta-cyclodextrin is from 1:1 to 1:5.

The present invention provides an insecticidal composition comprising (i) an effective amount of tau-fluvalinate; (ii) methyl-beta-cyclodextrin and (iii) an agriculturally acceptable carrier, wherein the tau-fluvalinate molecules interact chemically with the methyl-beta-cyclodextrin molecular matrix through intermolecular force(s) and the weight ratio of tau-fluvalinate to methyl-beta-cyclodextrin is from 1:3 to 1:5.

The present invention provides an insecticidal composition comprising (i) an effective amount of tau-fluvalinate; (ii) methyl-beta-cyclodextrin and (iii) an agriculturally acceptable carrier, wherein the tau-fluvalinate molecules interact chemically with the methyl-beta-cyclodextrin molecular matrix through intermolecular force(s) and the weight ratio of tau-fluvalinate to methyl-beta-cyclodextrin is 1:3.

The present invention provides an insecticidal composition comprising (i) an effective amount of tau-fluvalinate; (ii) methyl-beta-cyclodextrin and (iii) an agriculturally acceptable carrier, wherein the tau-fluvalinate molecules interact chemically with the methyl-beta-cyclodextrin molecular matrix through intermolecular force(s) and the weight ratio of tau-fluvalinate to methyl-beta-cyclodextrin is 1:5.

The present invention provides a fungicidal composition comprising (i) an effective amount of prothioconazole; (ii) cyclodextrin and (iii) an agriculturally acceptable carrier.

The present invention provides a fungicidal composition comprising (i) an effective amount of epoxiconazole; (ii) cyclodextrin and (iii) an agriculturally acceptable carrier.

The present invention provides a fungicidal composition comprising (i) an effective amount of propiconazole; (ii) cyclodextrin and (iii) an agriculturally acceptable carrier.

The present invention provides an insecticidal composition comprising (i) an effective amount of tau-fluvalinate; (ii) cyclodextrin and (iii) an agriculturally acceptable carrier.

The present invention provides an insecticidal composition comprising (i) an effective amount of bifenthrin; (ii) cyclodextrin and (iii) an agriculturally acceptable carrier.

The present invention provides an insecticidal composition comprising (i) an effective amount deltamithrin; (ii) cyclodextrin and (iii) an agriculturally acceptable carrier.

### An Inclusion Complex of Pesticides

The present invention provides a pesticidal guest/host inclusion complex comprising (i) guest pesticide and (ii) host cyclodextrin, wherein the guest pesticide is selected from triazole fungicide and pyrethroid insecticide.

The present invention provides a fungicidal guest/host inclusion complex comprising (i) guest triazole fungicide and (ii) host cyclodextrin.

The present invention provides an insecticidal guest/host inclusion complex comprising (i) guest pyrethroid insecticide and (ii) host cyclodextrin.

The present invention provides a fungicidal guest/host inclusion complex comprising (i) guest prothioconazole and (ii) host cyclodextrin.

The present invention provides a fungicidal guest/host inclusion complex comprising (i) guest epoxiconazole and (ii) host cyclodextrin.

The present invention provides a fungicidal guest/host inclusion complex comprising (i) guest propiconazole and (ii) host cyclodextrin.

The present invention provides an insecticidal guest/host inclusion complex comprising (i) guest tau-fluvalinate and (ii) host cyclodextrin.

The present invention provides an insecticidal guest/host inclusion complex comprising (i) guest bifenthrin and (ii) host cyclodextrin.

The present invention provides an insecticidal guest/host inclusion complex comprising (i) guest deltamithrin and (ii) host cyclodextrin.

In some embodiments, the guest/host inclusion complex comprises guest prothioconazole and host methylated β-cyclodextrin at a weight ratio from 1:1 to 1:5.

In some embodiments, the guest/host inclusion complex comprises guest prothioconazole and host methylated β-cyclodextrin at a weight ratio of 1:2.

In some embodiments, the guest/host inclusion complex comprises guest epoxiconazole and host methylated β-cyclodextrin at a weight ratio from 1:1 to 1:5.

In some embodiments, the guest/host inclusion complex comprises guest propiconazole and host methylated β-cyclodextrin at a weight ratio from 1:1 to 1:5.

In some embodiments, the guest/host inclusion complex comprises guest prothioconazole and host hydroxypropyl-β-cyclodextrin at a weight ratio from 1:1 to 1:5.

In some embodiments, the guest/host inclusion complex comprises guest prothioconazole and host hydroxypropyl-β-cyclodextrin at a weight ratio of 1:2.

In some embodiments, the guest/host inclusion complex comprises guest epoxiconazole and host hydroxypropyl-β-cyclodextrin at a weight ratio from 1:1 to1:5.

In some embodiments, the guest/host inclusion complex comprises guest epoxiconazole and host hydroxypropyl-β-cyclodextrin at a weight ratio of 1:2.

In some embodiments, the guest/host inclusion complex comprises guest propiconazole and host hydroxypropyl-γ-cyclodextrin at a weight ratio from 1:1 to 1:5.

In some embodiments, the guest/host inclusion complex comprises guest propiconazole and host hydroxypropyl-γ-cyclodextrin at a weight ratio of 1:2.

In some embodiments, the guest/host inclusion complex comprises guest tau-fluvalinate and host methylated β-cyclodextrin at a weight ratio from 1:1 to 1:5.

In some embodiments, the guest/host inclusion complex comprises guest tau-fluvalinate and host methylated β-cyclodextrin at a weight ratio from 1:3 to 1:5.

In some embodiments, the guest/host inclusion complex comprises guest bifenthrin and host methylated β-cyclodextrin at a weight ratio from 1:1 to 1:5.

In some embodiments, the guest/host inclusion complex comprises guest deltamithrin and host methylated β-cyclodextrin at a weight ratio from 1:1 to 1:5.

In some embodiments, the guest/host inclusion complex comprises guest bifenthrin and host methylated β-cyclodextrin at a weight ratio from 1:3 to 1:5.

In some embodiments, the guest/host inclusion complex comprises guest deltamithrin and host methylated β-cyclodextrin at a weight ratio from 1:3 to 1:5.

In some embodiments, the guest/host inclusion complex comprises guest tau-fluvalinate and host hydroxypropyl-β-cyclodextrin at a weight ratio from 1:1 to 1:5.

In some embodiments, the guest/host inclusion complex comprises guest bifenthrin and host hydroxypropyl-β-cyclodextrin at a weight ratio from 1:1 to 1:5.

In some embodiments, the guest/host inclusion complex comprises guest deltamithrin and host hydroxypropyl-β-cyclodextrin at a weight ratio from 1:1 to 1:5.

In some embodiments, the guest/host inclusion complex comprises guest tau-fluvalinate and host hydroxypropyl-γ-cyclodextrin at a weight ratio from 1:1 to 1:5.

In some embodiments, the guest/host inclusion complex comprises guest bifenthrin and host hydroxypropyl-γ-cyclodextrin at a weight ratio from 1:1 to 1:5.

In some embodiments, the guest/host inclusion complex comprises guest deltamithrin and host hydroxypropyl-γ-cyclodextrin at a weight ratio from 1:1 to 1:5.

In some embodiments, the guest/host inclusion complex comprises guest tau-fluvalinate and host hydroxypropyl-β-cyclodextrin at a weight ratio from 1:3 to 1:5.

In some embodiments, the guest/host inclusion complex comprises guest bifenthrin and host hydroxypropyl-β-cyclodextrin at a weight ratio from 1:3 to 1:5.

In some embodiments, the guest/host inclusion complex comprises guest deltamithrin and host hydroxypropyl-β-cyclodextrin at a weight ratio from 1:3 to 1:5.

In some embodiments, the guest/host inclusion complex comprises guest tau-fluvalinate and host hydroxypropyl-γ-cyclodextrin at a weight ratio from 1:3 to 1:5.

In some embodiments, the guest/host inclusion complex comprises guest bifenthrin and host hydroxypropyl-γ-cyclodextrin at a weight ratio from 1:3 to 1:5.

In some embodiments, the guest/host inclusion complex comprises guest deltamithrin and host hydroxypropyl-γ-cyclodextrin at a weight ratio from 1:3 to 1:5.

In some embodiments, the cyclodextrin is a methyl-beta-cyclodextrin. In some embodiments, the cyclodextrin is a hydroxypropyl-beta-cyclodextrin. In some embodiments, the cyclodextrin is a hydroxypropyl-gamma-cyclodextrin.

Suitable cyclodextrins that may be used in connection with the subject invention include but are not limited to Cavamax™ W7 (beta-cyclodextrin), Cavamax™ W8 (gamma-cyclodextrin), Cavasol™ W7M (methyl-beta-cyclodextrin), Cavasol™ W7HP (hydroxypropyl-beta-cyclodextrin), and Cavasol™ W8HP (hydroxypropyl-gamma-cyclodextrin) manufactured by Wacker Chemie AG.

The size of the cyclodextrin which is used in the present invention correlated with the size and structure of the agrochemical.

In some embodiments, the cyclodextrin has the following structure:

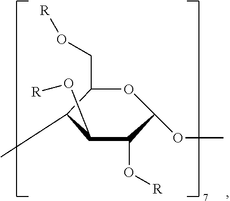

wherein R is H or methyl.

In some embodiments, the cyclodextrin has the following structure:

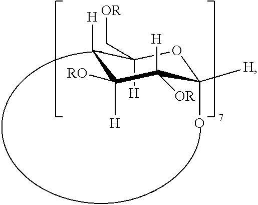

wherein R is

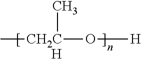

and n is an integer equal to or greater than 0.

In some embodiments, at least one of the agrochemical is complexed with or encapsulated within the cyclodextrin.

### Use of Cyclodextrin for Increasing Biological Activity

The present invention provides the use of cyclodextrin for increasing the fungicidal activity of triazole fungicides.

The present invention provides the use of cyclodextrin for increasing the biological activity of triazole fungicides.

The present invention provides the use of cyclodextrin for increasing the insecticidal activity of pyrethroid insecticids.

The present invention provides the use of cyclodextrin for increasing the biological activity of pyrethroid insecticides.

The present invention provides the use of cyclodextrin for enhancing the fungicidal activity of triazole fungicides.

The present invention provides the use of cyclodextrin for enhancing the insecticidal activity of pyrethroid insecticides.

The present invention provides the use of cyclodextrin for enhancing the biological activity of triazole fungicides.

The present invention provides the use of cyclodextrin for enhancing the biological activity of pyrethroid insecticides.

The present invention provides the use of cyclodextrin for prolonging the fungicidal effect of triazole fungicides.

The present invention provides the use of cyclodextrin for prolonging the fungicidal activity of triazole fungicides.

The present invention provides the use of cyclodextrin for prolonging the insecticidal effect of pyrethroid insecticide.

The present invention provides the use of cyclodextrin for prolonging the insecticidal activity of pyrethroid insecticides.

The present invention provides the use of cyclodextrin for increasing retention of triazole fungicide by a plant and/or increasing bioavailability of triazole fungicide to a plant.

The present invention provides the use of cyclodextrin for increasing retention of pyrethroid insecticide by a plant and/or increasing bioavailability of pyrethroid insecticide to a plant.

The present invention provides the use of cyclodextrin for increasing retention of pesticide by plant cuticles and/or increasing bioavailability of pesticide to plant cuticle, wherein the pesticide is selected from triazole fungicide and pyrethroid insecticide.

In some embodiments, the triazole fungicide may include but is not limited to prothioconazole, epoxiconazole, cyproconazole, myclobutanil, metconazole, difenoconazole, tebuconazole, tetraconazole, fenbuconazole, propiconazole, fluquinconazole, flusilazole, flutriafol, triadimefon, triadimenol, triticonazole; uniconazole, simeconazole, hexaconazole, imibenconazole, bitertanol; bromuconazole, ipconazole, itraconazole, paclobutrazol, penconazole, diniconazole and diniconazole-M.

In some embodiments, the pyrethroid insecticide may include but is not limited to acrinathrin, allethrin (d-cis-trans, d-trans), beta-cyfluthrin, bifenthrin, bioallethrin, bioallethrin-S-cyclopentyl-isomer, bioethanomethrin, biopermethrin, bioresmethrin, chlovaporthrin, cis-cypermethrin, cis-resmethrin, cis-permethrin, clocythrin, cycloprothrin, cyflu-thrin, cyhalothrin, cypermethrin (alpha-, beta-, theta-, zeta-), cyphenothrin, DDT, deltamethrin, empenthrin (1R isomer), esfenvalerate, etofenprox, fenfluthrin, fenpropathrin, fenpyrithrin, fen-valerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans isomer), prallethrin, profluthrin, protrifenbute, pyresmethrin, resmethrin, RU 15525, silafluofen, tau-fluvalinate, tefluthrin, terallethrin, tetramethrin (1R-isomer), tralomethrin, transfluthrin, ZXI 8901, pyrethrins (pyrethrum)) oxadiazines (for example indoxacarb).

The present invention provides the use of cyclodextrin for increasing the fungicidal effect of prothioconazole.

The present invention provides the use of cyclodextrin for increasing the fungicidal effect of epoxiconazole.

The present invention provides the use of cyclodextrin for increasing the fungicidal effect of propiconazole.

The present invention provides the use of cyclodextrin for increasing the insecticidal effect of tau-fluvalinate.

The present invention provides the use of cyclodextrin for increasing the insecticidal effect of bifenthrin.

The present invention provides the use of cyclodextrin for increasing the insecticidal effect of deltamithrin.

The present invention provides the use of cyclodextrin for increasing the biological activity of tau-fluvalinate.

The present invention provides the use of cyclodextrin for increasing the biological activity of bifenthrin.

The present invention provides the use of cyclodextrin for increasing the biological activity of deltamithrin.

The present invention provides the use of cyclodextrin for increasing the biological activity of prothioconazole.

The present invention provides the use of cyclodextrin for increasing the biological activity of epoxiconazole.

The present invention provides the use of cyclodextrin for increasing the biological activity of propiconazole.

The present invention provides the use of cyclodextrin for prolonging the fungicidal effect of prothioconazole.

The present invention provides the use of cyclodextrin for prolonging the fungicidal effect of epoxiconazole.

The present invention provides the use of cyclodextrin for prolonging the fungicidal effect of propiconazole.

The present invention provides the use of cyclodextrin for prolonging the insecticidal effect of tau-fluvalinate.

The present invention provides the use of cyclodextrin for prolonging the insecticidal effect of bifenthrin.

The present invention provides the use of cyclodextrin for prolonging the insecticidal effect of deltamithrin.

The present invention provides the use of cyclodextrin for increasing retention of prothioconazole by plant cuticles and/or increasing bioavailability of prothioconazole to plant cuticles.

The present invention provides the use of cyclodextrin for increasing retention of epoxiconazole by plant cuticles and/or increasing bioavailability of epoxiconazole to plant cuticles.

The present invention provides the use of cyclodextrin for increasing retention of propiconazole by plant cuticles and/or increasing bioavailability of propiconazole to plant cuticles.

The present invention provides the use of cyclodextrin for, increasing retention of tau-fluvalinate by plant cuticles and/or increasing bioavailability of tau-fluvalinate to plant cuticles.

The present invention provides the use of cyclodextrin for increasing retention of bifenthrin by plant cuticles and/or increasing bioavailability of bifenthrin to plant cuticles.

The present invention provides the use of cyclodextrin for increasing retention of deltamithrin by plant cuticles and/or increasing bioavailability of deltamithrin to plant cuticles.

The present invention provides the use of cyclodextrin for increasing biological effect of prothioconazole.

The present invention provides the use of cyclodextrin for increasing biological effect of epoxiconazole.

The present invention provides the use of cyclodextrin for increasing biological effect of propiconazole.

The present invention provides the use of cyclodextrin for increasing biological effect of tau-fluvalinate.

The present invention provides the use of cyclodextrin for increasing biological effect of bifenthrin.

The present invention provides the use of cyclodextrin for increasing biological effect of deltamithrin.

The present invention provides the use of cyclodextrin for prolonging the fungicidal effect of prothioconazole.

The present invention provides the use of cyclodextrin for prolonging the insecticidal effect of tau-fluvalinate.

The present invention provides the use of cyclodextrin for prolonging the fungicidal effect of epoxiconazole.

The present invention provides the use of cyclodextrin for prolonging the fungicidal effect of propiconazole.

The present invention provides the use of cyclodextrin for prolonging the insecticidal effect of bifenthrin.

The present invention provides the use of cyclodextrin for prolonging the insecticidal effect of deltamithrin.

The present invention provides the use of cyclodextrin for prolonging the fungicidal activity of prothioconazole.

The present invention provides the use of cyclodextrin for prolonging the fungicidal activity of epoxiconazole.

The present invention provides the use of cyclodextrin for prolonging the fungicidal activity of propiconazole.

The present invention provides the use of cyclodextrin for prolonging the insecticidal activity of tau-fluvalinate.

The present invention provides the use of cyclodextrin for prolonging the insecticidal activity of bifenthrin.

The present invention provides the use of cyclodextrin for prolonging the insecticidal activity of deltamithrin.

The present invention provides the use of cyclodextrin for increasing retention of prothioconazole by a plant and/or increasing bioavailability of prothioconazole to a plant.

The present invention provides the use of cyclodextrin for increasing retention of epoxiconazole by a plant and/or increasing bioavailability of epoxiconazole to a plant.

The present invention provides the use of cyclodextrin for increasing retention of propiconazole by a plant and/or increasing bioavailability of propiconazole to a plant.

The present invention provides the use of cyclodextrin for increasing retention of tau-fluvalinate by a plant and/or increasing bioavailability of tau-fluvalinate to a plant.

The present invention provides the use of cyclodextrin for increasing retention of bifenthrin by a plant and/or increasing bioavailability of bifenthrin to a plant.

The present invention provides the use of cyclodextrin for increasing retention of deltamithrin by a plant and/or increasing bioavailability of deltamithrin to a plant.

The present invention provides the use of cyclodextrin for enhancing the biological activity of pesticides.

The present invention provides the use of cyclodextrin for enhancing the biological activity of pesticides on plants.

The present invention provides the use of cyclodextrin for increasing retention of pesticides by a plant and/or increasing bioavailability of pesticides to a plant.

In some embodiments, the cyclodextrin is α (alpha)-cyclodextrin: 6-membered sugar ring molecule. In some embodiments, the cyclodextrin is β (beta)-cyclodextrin: 7-membered sugar ring molecule. In some embodiments, the cyclodextrin is γ (gamma)-cyclodextrin: 8-membered sugar ring molecule.

In some embodiments, the cyclodextrin is alkylated. In some embodiments, the cyclodextrin is alkylated with C₁-C₅ alkyl group. In some embodiments, the cyclodextrin is methylated. In some embodiments, the alkyl group is substituted with hydroxyl group.

Cyclodextrin includes methyl derivatives of cyclodextrin and hydroxypropyl derivatives of cyclodextrin.

In some embodiments, the cyclodextrin is a methyl-beta-cyclodextrin. In some embodiments, the cyclodextrin is a hydroxypropyl-beta-cyclodextrin. In some embodiments, the cyclodextrin is a hydroxypropyl-gamma-cyclodextrin.

Suitable cyclodextrins that may be used in connection with the subject invention include but are not limited to Cavamax™ W7 (beta-cyclodextrin), Cavamax™ W8 (gamma-cyclodextrin), Cavasol™ W7M (methyl-beta-cyclodextrin), Cavasol™ W7HP (hydroxypropyl-beta-cyclodextrin), and Cavasol™ W8HP (hydroxypropyl-gamma-cyclodextrin) manufactured by Wacker Chemie AG.

The size of the cyclodextrin which is used in the present invention correlated with the size and structure of the agrochemical.

In some embodiments, the cyclodextrin has the following structure:

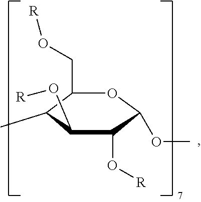

wherein R is H or methyl.

In some embodiments, the cyclodextrin has the following structure:

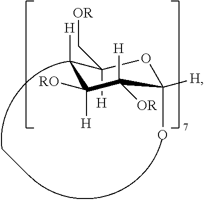

wherein R is

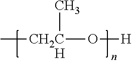

and n is an integer equal to or greater than 0.

In some embodiments, the agrochemical is complexed with or encapsulated within the cyclodextrin. In some embodiments, the pesticide is complexed with or encapsulated within the cyclodextrin.

In some embodiments, the composition comprises at least one type of cyclodextrin. In some embodiments, the composition comprises at least two types of cyclodextrin

### Method of Delivery, Controlling Using Cyclodextrin.

The present invention also provides a pesticidal delivery system comprising an effective amount of at least one pesticide and cyclodextrin wherein the pesticide interacts with the cyclodextrin through intermolecular force(s).

The present invention also provides a pesticidal delivery system comprising an effective amount of at least one pesticide and cyclodextrin wherein the pesticide interacts chemically with the cyclodextrin through intermolecular force(s).

In some embodiments, the pesticide is triazole fungicide. In some embodiments, the pesticide is pyrethroid insecticide.

The present invention also provides a pesticidal delivery system comprising an effective amount of at least one pesticide and cyclodextrin wherein the pesticide interacts chemically with the cyclodextrin through intermolecular force(s) and wherein the pesticide is selected from triazole fungicide and pyrethroid insecticide.

The present invention also provides a fungicidal delivery system comprising an effective amount of triazole fungicide and cyclodextrin wherein the triazole fungicide interacts with the cyclodextrin through intermolecular force(s).

The present invention also provides an insecticidal delivery system comprising an effective amount of pyrethroid insecticide and cyclodextrin wherein the pyrethroid insecticide interacts with the cyclodextrin through intermolecular force(s).

The present invention also provides a fungicidal delivery system comprising an effective amount of triazole fungicide and cyclodextrin wherein the triazole fungicide interacts chemically with the cyclodextrin through intermolecular force(s).

The present invention also provides an insecticidal delivery system comprising an effective amount of pyrethroid insecticide and cyclodextrin wherein the pyrethroid insecticide interacts chemically with the cyclodextrin through intermolecular force(s).

The present invention also provides a method for controlling pest comprising contacting (i) the pest or a locus thereof, (ii) a plant or a locus or propagation material thereof, (iii) soil, and/or (iv) an area in which pest infestation is to be prevented with any one of the compositions, inclusion complexes or delivery systems described herein.

The present invention also provides a method for prolonging the pesticidal effect of a pesticide comprising contacting (i) the pest or a locus thereof, (ii) a plant or a locus or propagation material thereof, (iii) soil, and/or (iv) an area in which pest infestation is to be prevented with any one of the compositions, inclusion complexes or delivery systems described herein.

The present invention also provides a method for increasing retention of a pesticide by a plant comprising contacting (i) the pest or a locus thereof, (ii) the plant or a locus or propagation material thereof, (iii) soil, and/or (iv) an area in which pest infestation is to be prevented with any one of the compositions, inclusion complexes or delivery systems described herein.

In some embodiments, the pesticidal effect is prolonged by at least 1 week compared to when the same pesticide is applied without cyclodextrin. In some embodiments, the pesticidal effect of the pesticide is prolonged by at least 2 weeks compared to when the same pesticide is applied without cyclodextrin. In some embodiments, the pesticide effect of the pesticide is prolonged by at least 3 weeks compared to when the same pesticide is applied without cyclodextrin.

In some embodiments, the pesticide is retained by the plant for at least 1 week after application. In some embodiments, the pesticide is retained by the plant for at least 2 weeks after application. In some embodiments, the pesticide is retained by the plant for at least 3 weeks after application.

In some embodiments, the pest is a phytopathogenic fungi.

In some embodiments, the pest is an unwanted insect.

In some embodiments, the application rate is 1 g a.i./ha to 100 g a.i./ha. In some embodiments, the application rate is 5 g a.i./ha to 55 g a.i./ha. In some embodiments, the application rate is 6.25 g a.i./ha. In some embodiments, the application rate is 12.5 g a.i./ha. In some embodiments, the application rate is 25 g a.i./ha. In some embodiments, the application rate is 50 g a.i./ha.

In some embodiments, the pesticide is applied at a rate from 0.1 ppm to 1000 ppm. In some emboidments, the pesticide is applied at a rate from 0.1 ppm to 1 ppm. In some embodiments, the pesticide is applied at a rate from 1 ppm to 500 ppm. In some embodiments, the pesticide is applied at a rate from 25 ppm to 250 ppm. In some embodiments, the pesticide is applied at a rate from 30 ppm to 65 ppm. In some embodiments, the pesticide is applied at a rate from 125 ppm to 250 ppm.

In some embodiments, the pesticide is applied at a rate of 1000 ppm. In some embodiments, the pesticide is applied at a rate of 500 ppm. In some embodiments, the pesticide is applied at a rate of 250 ppm. In some embodiments, the pesticide is applied at a rate of 125 ppm. In some embodiments, the pesticide is applied at a rate of 62.5 ppm. In some embodiments, the pesticide is applied at a rate of 31.25 ppm. In some embodiments, the pesticide is applied at a rate of 0.3 ppm. In some embodiments, the pesticide is applied at a rate of 0.1 ppm.

In some embodiments, the method is effective for preventing infestation of the pest. In some embodiments, the method is effective for curing infestation of the pest. In some embodiments, the method is effective for increasing the pesticidal activity of the pesticide. In some embodiments, the method is effective for prolonging the pesticidal effect of the pesticide. In some embodiments, the method is effective for increasing retention of the pesticide by the plant. In some embodiments, the method is effective for increasing the bioavailablity of the pesticide to the plant.

In some embodiments, the method is effective for decreasing the half maximal effective concentration (EC₅₀) of the pesticide. In some embodiments, the method is effective for decreasing the EC₅₀ by at least 10%. In some embodiments, the method is effective for decreasing the EC₅₀ by at least 25%. In some embodiments, the method is effective for decreasing the EC₅₀ by at least 35%. In some embodiments, the method is effective for decreasing the EC₅₀ by at least 50%.

In some embodiments, the method is effective for decreasing the lethal concentration 50 (LC₅₀) of the pesticide. In some embodiments, the method is effective for decreasing the LC₅₀ by at least 10%. In some embodiments, the method is effective for decreasing the LC₅₀ by at least 25%. In some embodiments, the method is effective for decreasing the LC₅₀ by at least 50%. In some embodiments, the method is effective for decreasing the LC₅₀ by at least 75%. In some embodiments, the method is effective for decreasing the LC₅₀ by at least 90%.

In some embodiments, the method is effective for decreasing the lethal concentration 90 (LC₉₀) of the pesticide. In some embodiments, the method is effective for decreasing the LC₉₀ by at least 10%. In some embodiments, the method is effective for decreasing the LC₉₀ by at least 25%. In some embodiments, the method is effective for decreasing the LC₉₀ by at least 50%. In some embodiments, the method is effective for decreasing the LC₉₀ by at least 75%. In some embodiments, the method is effective for decreasing the LC₉₀ by at least 90%.

In some embodiments, the method further comprises applying at least one additional agrochemical to the pest or the plant or the locus or propagation material thereof.

In some embodiments, the method further comprises applying at least one additional agrochemical to (i) the pest or a locus thereof, (ii) a plant or a locus or propagation material thereof, (iii) soil, and/or (iv) an area in which pest infestation is to be prevented.

In some embodiments, the composition, inclusion complex or delivery system is tank mixed with the additional agrochemical or applied sequentially with the additional agrochemical.

In some embodiments, the composition further comprises applying an additional adjuvant.

In some emboidments, the composition, inclusion complex or delivery system is tank mixed with the additional adjuvant or applied sequentially with the additional adjuvant.

The present invention provides a method for improving pest control comprising applying a composition comprising pyrethroids insecticide and cyclodextrin wherein the insecticide interacts with the cyclodextrin through intermolecular force(s).

The present invention provides a method for improving pest control comprising applying a composition comprising triazole fungicide and cyclodextrin wherein the triazole fungicide interacts with the cyclodextrin through intermolecular force(s).

The present invention also provides a method for increasing the biological activity of a pesticide on a pest comprising interacting pesticide with cyclodextrin through intermolecular force(s) prior to application of the pesticide to a plant and/or soil.

The present invention also provides a method for increasing the biological activity of a pesticide on a plant comprising interacting chemically the pesticide with cyclodextrin through intermolecular force(s) prior to application of the pesticide to a plant and/or soil and wherein the pesticide is selected from triazole fungicide and pyrethroid insecticide.

The present invention also provides a method for increasing biological activity of a triazole fungicide on a fungus comprising interacting the triazole fungicide with cyclodextrin through intermolecular force(s) prior to application of the triazole fungicide to a plant and/or soil.

The present invention also provides a method for increasing biological activity of a pyrethroid insecticide on an insect comprising interacting the pyrethroid insecticide with cyclodextrin through intermolecular force(s) prior to application of the pyrethroid insecticide to a plant and/or soil.

The present invention also provides a method for increasing fungicidal activity of a triazole fungicide on a fungus comprising interacting the triazole fungicide with cyclodextrin through intermolecular force(s) prior to application of the triazole fungicide to a plant and/or soil.

The present invention also provides a method for increasing insecticidal activity of a pyrethroid insecticide on an insect comprising interacting the pyrethroid insecticide with cyclodextrin through intermolecular force(s) prior to application of the pyrethroid insecticide to a plant and/or soil.

The present invention also provides a method for increasing retention of a pesticide by a plant and/or increasing bioavailability of a pesticide to a plant comprising interacting chemically the pesticide with cyclodextrin through intermolecular force(s) prior to application of the pesticide to the plant and/or soil, and wherein the pesticide is selected from triazole fungicide and pyrethroid insecticide.

The present invention also provides a method for increasing bioavailability of pesticide selected from triazole fungicide and pyrethroid insecticide comprising interacting the pesticide with cyclodextrin by complexing the pesticide with the cyclodextrin or encapsulating the pesticide within the cyclodextrin prior to application of the pesticide to a plant and/or soil.

The present invention provides a method for improving pest control comprising applying a composition comprising pyrethroids insecticide and cyclodextrin wherein the insecticide interacts chemically with the cyclodextrin through intermolecular force(s).

The present invention provides a method for improving pest control comprising applying a composition comprising triazole fungicide and cyclodextrin wherein the triazole fungicide interacts chemically with the cyclodextrin through intermolecular force(s).

The present invention also provides a method for increasing the biological activity of a pesticide on a pest comprising interacting chemically pesticide with cyclodextrin through intermolecular force(s) prior to application of the pesticide to a plant and/or soil.

The present invention also provides a method for increasing biological activity of a triazole fungicide on a fungus comprising interacting chemically the triazole fungicide with cyclodextrin through intermolecular force(s) prior to application of the triazole fungicide to a plant and/or soil.

The present invention also provides a method for increasing biological activity of a pyrethroid insecticide on an insect comprising interacting chemically the pyrethroid insecticide with cyclodextrin through intermolecular force(s) prior to application of the pyrethroid insecticide to a plant and/or soil.

The present invention also provides a method for increasing fungicidal activity of a triazole fungicide on a fungus comprising interacting chemically the triazole fungicide with cyclodextrin through intermolecular force(s) prior to application of the triazole fungicide to a plant and/or soil.

The present invention also provides a method for increasing insecticidal activity of a pyrethroid insecticide on an insect comprising interacting chemically the pyrethroid insecticide with cyclodextrin through intermolecular force(s) prior to application of the pyrethroid insecticide to a plant and/or soil.

The present invention also provides a method for increasing bioavailability of pesticide selected from triazole fungicide and pyrethroid insecticide comprising interacting chemically the pesticide with cyclodextrin by complexing the pesticide with the cyclodextrin or encapsulating the pesticide within the cyclodextrin prior to application of the pesticide to a plant and/or soil.

Increasing biological activity refers to curative, knock down, preventive and/or persistence performance.

In some embodiments, the triazole fungicide may include but is not limited to prothioconazole, epoxiconazole, cyproconazole, myclobutanil, metconazole, difenoconazole, tebuconazole, tetraconazole, fenbuconazole, propiconazole, fluquinconazole, flusilazole, flutriafol, triadimefon, triadimenol, triticonazole; uniconazole, simeconazole, hexaconazole, imibenconazole, bitertanol; bromuconazole, ipconazole, itraconazole, paclobutrazol, penconazole, diniconazole and diniconazole-M.

In some embodiments, the pyrethroid insecticide may include but is not limited to acrinathrin, allethrin (d-cis-trans, d-trans), beta-cyfluthrin, bifenthrin, bioallethrin, bioallethrin-S-cyclopentyl-isomer, bioethanomethrin, biopermethrin, bioresmethrin, chlovaporthrin, cis-cypermethrin, cis-resmethrin, cis-permethrin, clocythrin, cycloprothrin, cyflu-thrin, cyhalothrin, cypermethrin (alpha-, beta-, theta-, zeta-), cyphenothrin, DDT, deltamethrin, empenthrin (1R isomer), esfenvalerate, etofenprox, fenfluthrin, fenpropathrin, fenpyrithrin, fen-valerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans isomer), prallethrin, profluthrin, protrifenbute, pyresmethrin, resmethrin, RU 15525, silafluofen, tau-fluvalinate, tefluthrin, terallethrin, tetramethrin (1R-isomer), tralomethrin, transfluthrin, ZXI 8901, pyrethrins (pyrethrum)) oxadiazines (for example indoxacarb).

In preferred embodiments, the triazole fungicide is prothioconazole. In preferred embodiments, the triazole fungicide is epoxiconazole. In preferred embodiments, the triazole fungicide is propiconazole.

In preferred embodiments, the pyrethroid insecticide is tau-fluvalinate. In preferred embodiments, the pyrethroid insecticide is bifenthrin. In preferred embodiments, the pyrethroid insecticide is deltamithrin.

In some embodiments, the cyclodextrin is α (alpha)-cyclodextrin: 6-membered sugar ring molecule. In some embodiments, the cyclodextrin is β (beta)-cyclodextrin: 7-membered sugar ring molecule. In some embodiments, the cyclodextrin is γ (gamma)-cyclodextrin: 8-membered sugar ring molecule.

In some embodiment the cyclodextrin is alkylated. In some embodiments, the cyclodextrin is alkylated with C1-C₅ alkyl group. In some embodiments, the cyclodextrin is methylated. In some embodiments, the alkyl group is substituted with hydroxyl group.

Cyclodextrin includes to methyl derivatives of cyclodextrin and hydroxypropyl derivatives of cyclodextrin.

In some embodiments, the cyclodextrin is a methyl-beta-cyclodextrin. In some embodiments, the cyclodextrin is a hydroxypropyl-beta-cyclodextrin. In some embodiments, the cyclodextrin is a hydroxypropyl-gamma-cyclodextrin.

Suitable cyclodextrins that may be used in connection with the subject invention include but are not limited to Cavamax™ W7 (beta-cyclodextrin), Cavamax™ W8 (gamma-cyclodextrin), Cavasol™ W7M (methyl-beta-cyclodextrin), Cavasol™ W7HP (hydroxypropyl-beta-cyclodextrin), and Cavasol™ W8HP (hydroxypropyl-gamma-cyclodextrin) manufactured by Wacker Chemie AG.

The size of the cyclodextrin which is used in the present invention correlated with the size and structure of the agrochemical.

In some embodiments, the cyclodextrin has the following structure:

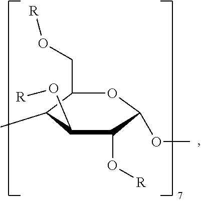

wherein R is H or methyl.

In some embodiments, the cyclodextrin has the following structure:

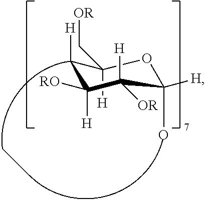

wherein R is

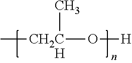

and n is an integer equal to or greater than 0.

In some embodiments, the agrochemical is complexed with or encapsulated within the cyclodextrin. In some embodiments, the pesticide is complexed with or encapsulated within the cyclodextrin.

In some embodiments, the composition comprises at least one type of cyclodextrin. In some embodiments, the composition comprises at least two types of cyclodextrin

The present invention provides a method for prolonging the controlled effect of pesticide selected from triazole fungicide and pyrethroids comprising applying any one of the compositions, inclusion complexes or delivery systems described herein to a plant/or soil.

The present invention provides a method for prolonging the controlled effect of pesticide selected from triazole fungicide and pyrethroid insecticide comprising applying a composition comprising the pesticide and cyclodextrin wherein the pesticide is interacted with the cyclodextrin through intermolecular force(s).

The present invention provides a method for prolonging the controlled effect of pesticide selected from triazole fungicide and pyrethroid insecticde comprising applying a composition comprising the pesticide and cyclodextrin wherein the pesticide is interacted chemically with the cyclodextrin through intermolecular force(s).

The present invention also provides use of cyclodextrin for increasing retention of a pesticide by a plant and/or increasing bioavailability of a pesticide to a plant, wherein the pesticide is selected from triazole fungicide and pyrethroid insecticide.

The present invention also provides use of cyclodextrin for prolonging or increasing the biological activity of triazole fungicide.

The present invention also provides use of cyclodextrin for prolonging or increasing the biological activity of pyrethroid insecticide.

The present invention provides the use of cyclodextrin for prolonging the biological effect of prothioconazole.

The present invention provides the use of cyclodextrin for prolonging the biological effect of epoxiconazole.

The present invention provides the use of cyclodextrin for prolonging the biological effect of propiconazole.

The present invention provides the use of cyclodextrin for prolonging and facilitating the biological effect of tau-fluvalinate.

The present invention provides the use of cyclodextrin for prolonging and facilitating the biological effect of bifenthrin.

The present invention provides the use of cyclodextrin for prolonging and facilitating the biological effect of deltamithrin.

Cyclodextrin was also found to act as an inactive ingredient which affects the persistence activity of the pesticide.

The activity lasted for at least 1 week, 2 weeks, 3 weeks, 4 weeks, and/or 5 weeks.

In some embodiments, the biological activity lasted for at least 7 days, 14 days, and/or 21 days.

In some embodiments, the triazole fungicide may include but is not limited to prothioconazole, epoxiconazole, cyproconazole, myclobutanil, metconazole, difenoconazole, tebuconazole, tetraconazole, fenbuconazole, propiconazole, propiconazole, fluquinconazole, flusilazole, flutriafol, triadimefon, triadimenol, triticonazole; uniconazole, simeconazole, hexaconazole, imibenconazole, bitertanol; bromuconazole, ipconazole, itraconazole, paclobutrazol, penconazole, diniconazole and diniconazole-M.

In some embodiments, the pyrethroid insecticide may include but is not limited to acrinathrin, allethrin (d-cis-trans, d-trans), beta-cyfluthrin, bifenthrin, bioallethrin, bioallethrin-S-cyclopentyl-isomer, bioethanomethrin, biopermethrin, bioresmethrin, chlovaporthrin, cis-cypermethrin, cis-resmethrin, cis-permethrin, clocythrin, cycloprothrin, cyflu-thrin, cyhalothrin, cypermethrin (alpha-, beta-, theta-, zeta-), cyphenothrin, DDT, deltamethrin, empenthrin (1R isomer), esfenvalerate, etofenprox, fenfluthrin, fenpropathrin, fenpyrithrin, fen-valerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans isomer), prallethrin, profluthrin, protrifenbute, pyresmethrin, resmethrin, RU 15525, silafluofen, tau-fluvalinate, tefluthrin, terallethrin, tetramethrin (1R-isomer), tralomethrin, transfluthrin, ZXI 8901, pyrethrins (pyrethrum)) oxadiazines (for example indoxacarb).

In some embodiments, the cyclodextrin is α (alpha)-cyclodextrin: 6-membered sugar ring molecule. In some embodiments, the cyclodextrin is β (beta)-cyclodextrin: 7-membered sugar ring molecule. In some embodiments, the cyclodextrin is γ (gamma)-cyclodextrin: 8-membered sugar ring molecule.

In some embodiment the cyclodextrin is alkylated. In some embodiments, the cyclodextrin is alkylated with C₁-C₅ alkyl group. In some embodiments, the cyclodextrin is methylated. In some embodiments, the alkyl group is substituted with hydroxyl group.

Cyclodextrin includes methyl derivatives of cyclodextrin and hydroxypropyl derivatives of cyclodextrin.

In some embodiments, the cyclodextrin is a methyl-beta-cyclodextrin. In some embodiments, the cyclodextrin is a hydroxypropyl-beta-cyclodextrin. In some embodiments, the cyclodextrin is a hydroxypropyl-gamma-cyclodextrin.

Suitable cyclodextrins that may be used in connection with the subject invention include but are not limited to Cavamax™ W7 (beta-cyclodextrin), Cavamax™ W8 (gamma-cyclodextrin), Cavasol™ W7M (methyl-beta-cyclodextrin), Cavasol™ W7HP (hydroxypropyl-beta-cyclodextrin), and Cavasol™ W8HP (hydroxypropyl-gamma-cyclodextrin) manufactured by Wacker Chemie AG.

The size of the cyclodextrin which is used in the present invention correlated with the size and structure of the agrochemical.

In some embodiments, the cyclodextrin has the following structure:

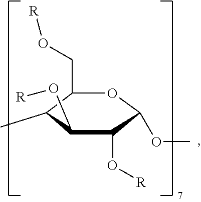

wherein R is H or methyl.

In some embodiments, the cyclodextrin has the following structure:

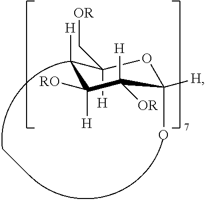

wherein R is

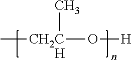

and n is an integer equal to or greater than 0.

In some embodiments, the agrochemical is complexed with or encapsulated within the cyclodextrin. In some embodiments, the pesticide is complexed with or encapsulated within the cyclodextrin.

In some embodiments, the composition comprises at least one type of cyclodextrin. In some embodiments, the composition comprises at least two types of cyclodextrin

### Methods of Use:

The present invention also provides a method for pest control by preventive, curative or persistence treatments of a plant disease caused by phytopathologic fungi comprising contacting a plant, a locus thereof or propagation material thereof with an effective amount of any one of the herein disclosed cyclodextrin compositions complexing or encapsulating a triazole fungicide.

The present invention also provides a method for pest control by preventive, curative or persistence treatments of a plant disease caused by phytopathologic fungi comprising contacting a plant, a locus thereof or propagation material thereof with an effective amount of any one of the compositions disclosed herein.

The present invention also provides a method for controlling unwanted insects comprising applying to the insects or an area infested with said insects an effective amount of at least one of any one of the compositions disclosed herein.

The present invention provides a method for controlling crop pests with composition comprising an effective amount of pesticide selected from triazol fungicide and pyrethroid insecticide and cyclodextrin, wherein the method comprises applying the composition to the pests, an area infected with said pests or an area in which infestation is to be prevented.

Controlling refers to preventive, persistence and curative and knock down treatments.

In some embodiments, the triazole fungicide may include but is not limited to prothioconazole, epoxiconazole, cyproconazole, myclobutanil, metconazole, difenoconazole, tebuconazole, tetraconazole, fenbuconazole, propiconazole, fluquinconazole, flusilazole, flutriafol, triadimefon, triadimenol, triticonazole; uniconazole, simeconazole, hexaconazole, imibenconazole, bitertanol; bromuconazole, ipconazole, itraconazole, paclobutrazol, penconazole, diniconazole and diniconazole-M.

In some embodiments, the pyrethroid insecticide may include but is not limited to acrinathrin, allethrin (d-cis-trans, d-trans), beta-cyfluthrin, bifenthrin, bioallethrin, bioallethrin-S-cyclopentyl-isomer, bioethanomethrin, biopermethrin, bioresmethrin, chlovaporthrin, cis-cypermethrin, cis-resmethrin, cis-permethrin, clocythrin, cycloprothrin, cyflu-thrin, cyhalothrin, cypermethrin (alpha-, beta-, theta-, zeta-), cyphenothrin, DDT, deltamethrin, empenthrin (1R isomer), esfenvalerate, etofenprox, fenfluthrin, fenpropathrin, fenpyrithrin, fen-valerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans isomer), prallethrin, profluthrin, protrifenbute, pyresmethrin, resmethrin, RU 15525, silafluofen, tau-fluvalinate, tefluthrin, terallethrin, tetramethrin (1R-isomer), tralomethrin, transfluthrin, ZXI 8901, pyrethrins (pyrethrum)) oxadiazines (for example indoxacarb).

In some embodiments, the cyclodextrin is α (alpha)-cyclodextrin: 6-membered sugar ring molecule. In some embodiments, the cyclodextrin is β (beta)-cyclodextrin: 7-membered sugar ring molecule. In some embodiments, the cyclodextrin is γ (gamma)-cyclodextrin: 8-membered sugar ring molecule.

In some embodiment the cyclodextrin is alkylated. In some embodiments, the cyclodextrin is alkylated with C₁-C₅ alkyl group. In some embodiments, the cyclodextrin is methylated. In some embodiments, the alkyl group is substituted with hydroxyl group.

Cyclodextrin includes methyl derivatives of cyclodextrin and hydroxypropyl derivatives of cyclodextrin.

In some embodiments, the cyclodextrin is a methyl-beta-cyclodextrin. In some embodiments, the cyclodextrin is a hydroxypropyl-beta-cyclodextrin. In some embodiments, the cyclodextrin is a hydroxypropyl-gamma-cyclodextrin.

Suitable cyclodextrins that may be used in connection with the subject invention include but are not limited to Cavamax™ W7 (beta-cyclodextrin), Cavamax™ W8 (gamma-cyclodextrin), Cavasol™ W7M (methyl-beta-cyclodextrin), Cavasol™

W7HP (hydroxypropyl-beta-cyclodextrin), and Cavasol W8HP (hydroxypropyl-gamma-cyclodextrin) manufactured by Wacker Chemie AG.

The size of the cyclodextrin which is used in the present invention correlated with the size and structure of the agrochemical.

In some embodiments, the cyclodextrin has the following structure:

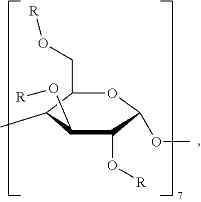

wherein R is H or methyl.

In some embodiments, the cyclodextrin has the following structure:

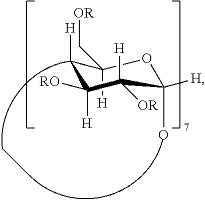

wherein R is

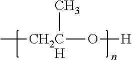

and n is an integer equal to or greater than 0.

In some embodiments, the agrochemical is complexed with or encapsulated within the cyclodextrin. In some embodiments, the pesticide is complexed with or encapsulated within the cyclodextrin.

In some embodiments, the composition comprises at least one type of cyclodextrin. In some embodiments, the composition comprises at least two types of cyclodextrin

Exemplary, non-limiting pests that can be controlled in this regard include herbs, fungi, insects, and nematodes.

The present compositions can be diluted and applied in a customary manner, for example by watering (drenching), drip irrigation, spraying, and/or atomizing.

The described compositions or mixtures may be applied to healthy or diseased plants. In another embodiment, the described compositions or mixtures can be used on various plants including but not limited to crops, seeds, bulbs, propagation material, or ornamental species.

The present invention provides a method for controlling a disease caused by phytopathogenic fungi on plants or propagation material thereof, comprising contacting the plants, the locus thereof or propagation material thereof with at least one of the herein defined complexes and/or compositions.

The present invention provides a method for controlling unwanted insects comprising applying to an area infested with said insects at least one of the herein defined complexes and/or compositions.

In some embodiments, the fungus is one of Leaf Blotch of Wheat (Mycosphaerella graminicola; anamorph: Septoria tritici), Wheat Brown Rust (Puccinia triticina), Stripe Rust (Puccinia striiformis f sp. tritici), Scab of Apple (Venturia inaequalis), Blister Smut of Maize (Ustilago maydis), Powdery Mildew of Grapevine (Uncinula necator), Barley scald (Rhynchosporium secalis), Blast of Rice (Magnaporthe grisea), Rust of Soybean (Phakopsora pachyrhizi), Glume Blotch of Wheat (Leptosphaeria nodorum), Powdery Mildew of Wheat (Blumeria graminis f sp. tritici), Powdery Mildew of Barley (Blumeria graminis f sp. hordei), Powdery Mildew of Cucurbits (Erysiphe cichoracearum), Anthracnose of Cucurbits (Glomerella lagenarium), Leaf Spot of Beet (Cercospora beticola), Early Blight of Tomato (Alternaria solani), and Net Blotch of Barley (Pyrenophora teres).

In some embodiments, the fungus is Zymoseptoria tritici. In some embodimens, the fungus is Phakopsora pachyrhizi.

Insects may include but are not limited to aphids, larvae and lepidoptera.

Aphids may include but are not limited to pollen beetle, stink bugs, helicoverpa and other aphids

In some embodiments, the insect is one of Isopoda (Oniscus asellus, Armadillidium vulgare, Porcellio scaber), Diplopoda (Blaniulus guttulatus), Chilopoda (philus carpophagus, Scutigera spp), Symphyla (Scutigerella immaculata), Thysanura (Lepisma saccharina), Collembola (Onychiurus armatus), Orthoptera (Acheta domesticus, Gryllotalpa spp., Locusta migratoria migratorioides, Melanoplus spp., Schistocerca gregaria), Blattaria (Blatta orientalis, Periplaneta americana, Leucophaea maderae, Blattella germanica), Dermaptera (Forficula auricularia), Isoptera (Reticulitermes spp), Phthiraptera (Pediculus humanus corporis, Haematopinus spp., Linognathus spp., Trichodectes spp., Damalinia spp), Thysanoptera (Hercinothrips femoralis, Thrips tabaci, Thrips palmi, Frankliniella occidentalis), Heteroptera (Eurygaster spp., Dysdercus intermedius, Piesma quadrata, Cimex lectularius, Rhodnius prolixus, Triatoma spp.) Homoptera (Aleurodes brassicae, Bemisia tabaci, Trialeurodes vaporariorum, Aphis gossypii, Brevicoryne brassicae, Cryptomyzus ribis, Aphis fabae, Aphis pomi, Eriosoma lanigerum, Hyalopterus arundinis, Phylloxera vastatrix, Pemphigus spp., Macrosiphum avenae, Myzus spp., Phorodon humuli, Rhopalosiphum padi, Empoasca spp., Euscelis bilobatus, Nephotettix cincticeps, Lecanium comi, Saissetia oleae, Laodelphax striatellus, Nilaparvata lugens, Aonidiella aurantii, Aspidiotus hederae, Pseudococcus spp., Psylla spp), Lepidoptera (Pectinophora gossypiella, Bupalus piniarius, Chematobia brumata, Lithocolletis blancardella, Hyponomeuta padella, Plutella xylostella, Malacosoma neustria, Euproctis chrysorrhoea, Lymantria spp., Bucculatrix thurberiella, Phyllocnistis citrella, Agrotis spp., Euxoa spp., Feltia spp., Earias insulana, Heliothis spp., Mamestra brassicae, Panolis flammea, Spodoptera spp., Trichoplusia ni, Carpocapsa pomonella, Pieris spp., Chilo spp., Pyrausta nubilalis, Ephestia kuehniella, Galleria mellonella, Tineola bisselliella, Tinea pellionella, Hofmannophila pseudospretella, Cacoecia podana, Capua reticulana, Choristoneura fumiferana, Clysia ambiguella, Homona magnanima, Tortrix viridana, Cnaphalocerus spp., Oulema oryzae), Coleoptera (Anobium punctatum, Rhizopertha dominica, Bruchidius obtectus, Acanthoscelides obtectus, Hylotrupes bajulus, Agelastica alni, Leptinotarsa decemlineata, Phaedon cochleariae, Diabrotica spp., Psylliodes chrysocephala, Epilachna varivestis, Atomaria spp., Oryzaephilus surinamensis, Anthonomus spp., Sitophilus spp., Otiorrhynchus sulcatus, Cosmopolites sordidus, Ceuthorrhynchus assimilis, Hypera postica, Dermestes spp., Trogoderma spp., Anthrenus spp., Attagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha melolontha, Amphimallon solstitialis, Costelytra zealandica, Lissorhoptrus oryzophilus), Hymenoptera (Diprion spp., Hoplocampa spp., Lasius spp., Monomorium pharaonis, Vespa spp), Diptera (Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae, Tipula paludosa, Hylemyia spp., Liriomyza spp), Siphonaptera (Xenopsylla cheopis, Ceratophyllus spp), Arachnida (Scorpio maurus, Latrodectus mactans, Acarus siro, Argas spp., Ornithodoros spp., Dermanyssus gallinae, Eriophyes ribis, Phyllocoptruta oleivora, Boophilus spp., Rhipicephalus spp., Amblyomma spp., Hyalomma spp., Ixodes spp., Psoroptes spp., Chorioptes spp., Sarcoptes spp., Tarsonemus spp., Bryobia praetiosa, Panonychus spp., Tetranychus spp., Hemitarsonemus spp., Brevipalpus spp), and plant-parasitic nematodes (Pratylenchus spp., Radopholus similis, Ditylenchus dipsaci, Tylenchulus semipenetrans, Heterodera spp., Globodera spp., Meloidogyne spp., Aphelenchoides spp., Longidorus spp., Xiphinema spp., Trichodorus spp., Bursaphelenchus spp).

In some embodiments, the insect is Spodoptera littoralis. In some embodiments, the insect is Rhopalosiphum padi. In some embodiments, the insect is Myzus prsicae.

Crops include cereals such as wheat, barley, rye, oats, sorghum and millet, rice, cassava and maize, or else crops of peanut, sugar beet, cotton, soya, oilseed rape, potato, tomato, peach and vegetables.

In some embodiments, the crop is wheat. In some embodiments, the crop is soybean. In some embodiments, the crop is caster oil leaves.

The present invention also provides a method for pest control by preventive, curative and/or persistence treatment of a plant disease caused by phytopathologic fungi comprising contacting a plant, a locus thereof or propagation material thereof with an effective amount of any one of the herein disclosed cyclodextrin compositions complexing or encapsulating the triazole fungicide.

The present invention also provides a method for pest control by preventive, curative and/or persistence treatment of a plant disease caused by insect comprising contacting a plant, a locus thereof or propagation material thereof with an effective amount of any one of the herein disclosed cyclodextrin compositions complexing or encapsulating the pyrethroid insecticide.

In some embodiments, the triazole fungicide is prothioconazole, the cyclodextrin is methyl-beta-cyclodextrin, hydroxypropyl-beta-cy cl o dextrin or hydroxy propyl-gamma-cyclodextrin, the weight ratio of prothioconazole to cyclodextrin is 1:2, and the prothioconazole is applied at a rate of 125 ppm or 250 ppm.

In some embodiments, the pyrethroid insecticide is tau-fluvalinate, the cyclodextrin is methyl-beta-cyclodextrin, the weight ratio of tau-fluvalinate to cyclodextrin is 1:3 or 1:5.

### Methods for Chemical Interaction Between the Guest Agrochemical Molecule and Host Cyclodextrin Molecular Assembly.

Cyclodextrin inclusion complexes with pesticides are prepared at several weight and molar ratios.

In some embodiments, the chemical interaction is obtained by Melting-In method.

In some embodiments, the chemical interaction is obtained by Co-Precipitation method.

### Melting-In Method:

Cyclodextrin inclusion complexes with pesticides are prepared by the Melting—In method by suspending the solid pesticide into a heated solution of cyclodextrin, the non-reacted pesticide is filtered off and the complex is isolated.

In some embodiments, the heated solution is at temperature between 25° C. to 50° C.

In some embodiments, the solution is mixed for period times of 2 to 24 hours.

In some embodiments, the solution is 5 ml to 100 ml.

Isolation may refer but is not limited to by lyophilization of the remaining solution, spray-drying, freeze-drying, diafiltration, dialysis, vacuum drying or heat drying.

### Co-Precipitation Method:

Cyclodextrin inclusion complexes with pesticides are prepared by the Co-Precipitation method by dissolving both the pesticide and the Cyclodextrin into Acetone. After reaction the solvent is evaporated and the dried cyclodextrin-pesticide complex is obtained.

The content of pesticide in the complex is determined by HPLC and the complexation is proven by DSC (differential scanning calorimetry).

The present invention provides a process for preparing the compositions described herein, wherein the process comprises (i) complexing the pesticide within cyclodextrin to form a pesticide-cyclodextrin inclusion complex, and (ii) dissolving the pesticide-cyclodextrin complex in an aqueous carrier to form the composition.

The present invention provides a process for preparing the compositions described herein, wherein the process comprises (i) complexing the pesticide within cyclodextrin to form a pesticide-cyclodextrin inclusion complex, and (ii) diluting the pesticide-cyclodextrin complex in an aqueous carrier to form the composition.

In some embodiments, the pesticide is a triazole fungicide. In some embodiments, the pesticide is a pyrethroid insecticide.

In some embodiments the complexing step comprises a melting in process.

In some embodiments, the complexing step comprises a co-precipitation process.

The present invention provides a process for preparing the compositions described herein, wherein the process comprises (i) encapsulating the pesticide within cyclodextrin to form a pesticide-cyclodextrin structure molecular assembly, and (ii) dissolving the pesticide-cyclodextrin structure in an aqueous carrier to form the composition.

The present invention provides a process for preparing the compositions described herein, wherein the process comprises (i) encapsulating the pesticide within cyclodextrin to form a pesticide-cyclodextrin structure molecular assembly, and (ii) diluting the pesticide-cyclodextrin structure in an aqueous carrier to form the composition

In some embodiments, the pesticide is a triazole fungicide. In some embodiments, the pesticide is a pyrethroid insecticide.

In some embodiments the encapsulation step comprises a melting in process.

In some embodiments, the encapsulation step comprises a co-precipitation process.

In some embodiments, the melting-in process comprising the steps of:

Suspending pesticide into a cyclodextrin solution, filtering off the non-reacted pesticide and isolating the complex by freeze-drying, spray-drying, vacuum drying or heat-drying of the remaining solution.

The present invention provides a composition prepared using the process described herein.

In some embodiments, the weight ratio of the pesticide to the cyclodextrin is about 1:1 to 1:10. In some embodiments, the weight ratio of the pesticide to the cyclodextrin is about 1:1 to 1:7. In some embodiments, the weight ratio of the pesticide to the cyclodextrin is about 1:1 to 1:5. In some embodiments, the weight ratio of the pesticide to the cyclodextrin is about 1:3 to 1:5. In some embodiments, the weight ratio of the pesticide to the cyclodextrin is about 1:2. In some embodiments, the weight ratio of the pesticide to the cyclodextrin is about 1:3. In some embodiments, the weight ratio of the pesticide to the cyclodextrin is about 1:4. In some embodiments, the weight ratio of the pesticide to the cyclodextrin is about 1:5.

In some embodiments, the agrochemical content of the agrochemical-cyclodextrin complex is determined by HPLC.

In some embodiment, the co-precipitation process is performed in organic solvent.

Organic solvents may include but is not limited to polar solvent, nonpolar solvent, protic, aprotic solvent.

Polar solvents may include but is not limited to acetone or methanol, acetonitrile, isopropylalcohol, dichloromethane, chloroform, pyridine, dimethylsulfoxide, tetrahydrofuran, polyethyleneglycol, glycofurol, ethylacetate anddimethylacetamide.

The present invention also provides a composition prepared using any one of the processes described herein.

Each embodiment disclosed herein is contemplated as being applicable to each of the other disclosed embodiments. Thus, all combinations of the various elements described herein are within the scope of the invention. In addition, the elements recited in composition embodiments can be used in the guest/host inclusion complex, delivery system, method and use embodiments described herein and vice versa.

This invention will be better understood by reference to the Experimental Details which follow, but those skilled in the art will readily appreciate that the specific experiments detailed are only illustrative of the invention as described more fully in the claims which follow thereafter.

The invention is illustrated by the following examples without limiting it thereby.

### Experimental Section:

Two types of cyclodexrtins were tested, methyl cyclodextrin and hydroxypropyl cyclodextrin, in different weight and molar ratios between cyclodextrin and agrochemical.

The cyclodextrin-pesticide was formulated in aqueous composition in different concentrations.

### Preparation of Cyclodextrin-Pesticide Complexes

### Melting-In Method:

Cyclodextrin inclusion complexes with pesticides were prepared according to the Melting-In method by suspending solid pesticide into a heated solution of cyclodextrin.

Non-reacted pesticide was filtered off and the complex was isolated by lyophilization of the remaining solution.

### Co-Precipitation Method:

Cyclodextrin inclusion complexes with pesticides were prepared by the Co-Precipitation method by dissolving both the pesticide and the Cyclodextrin into Acetone. After reaction, the solvent was evaporated and the dried cyclodextrin-pesticide complex was obtained.

The content of pesticide in the complex was determined by HPLC and the complexation was proven by DSC (differential scanning calorimetry).

Phase solubility studies were first carried out to get the solubility isotherms describing solubility enhancement of the pesticide as function of cyclodextrin concentration that reflect the tendency of cyclodextrins to form complexes with guest pesticide molecules.

### EXAMPLE 1

### Preparation of Prothioconazole-Cyclodextrin Complexes

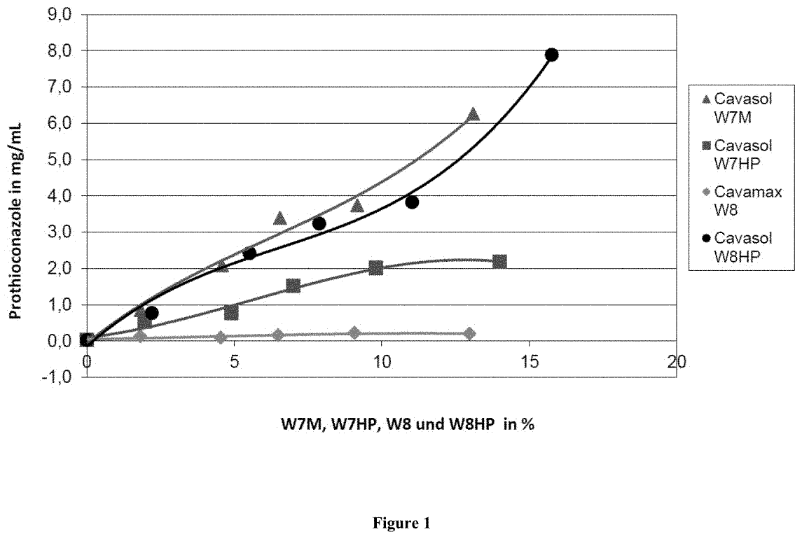

The preparation of the complexes was performed by suspending prothioconazole into a solution of cyclodextrin at 50° C. The ratio of starting materials was 1:1. The content of prothioconazole in the complex was determined by HPLC. Phase solubility isotherms were carried out for prothioconazole-cyclodextrin complexes (FIG. 1). CAVASOL® W7M and CAVASOL® W8HP showed the highest complexation ability indicating that the cavity size of methyl beta cyclodextrin and hydroxypropyl gamma CD-type is sufficiently large for formation of the inclusion complexation.

Cyclodextrin complexation of prothioconazole was also performed by the co-precipitation method at pesticide-cyclodextrin weight % ratios of 1:1 to 1:5. For CAVASOL® W7M, it was prepared by dissolving both the pesticide and the cyclodextrin into acetone and for CAVASOL® W7HP by dissolving both the pesticide and the cyclodextrin in methanol. After the reactions the solvent was evaporated and the dried cyclodextrin-pesticide complex was obtained.

The obtained prothioconazole-cyclodextrin prototype was dissolved in water to obtain an aqueous composition.

The fungicidal efficacy of prothioconazole in organic composition (commercial proline 50 EC) was compared to the fungicidal efficacy of prothioconazole-cyclodextrin prototype. Prothioconazole (PTZ) was used against different pathogens in different crops and the efficacy was measured.

Test 1: In Planta Evaluation of New Prothioconazole-Cyclodextrin Compositions Towards Zymoseptoria Tritici (Syn. Mycosphaerella graminicola) strain Mg Tri-R6 in wheat.

### Test 1a: Curative Treatment Test:

One (1) or three (3) days after the inoculation with the pathogen, inoculated wheat leaf fragments were treated with distilled water (Control), with DT-WC-P1-W7M-1:2-05T (75 g a.i./kg), or Proline (250 g a.i./L) at two rates of 25 and 50 g a.i./ha, corresponding to 125 and 250 μg a.i./ml or ppm, respectively.

The fungicidal activity of prothioconazole-cyclodextrin prototype and Proline 50 EC compositions was measured.

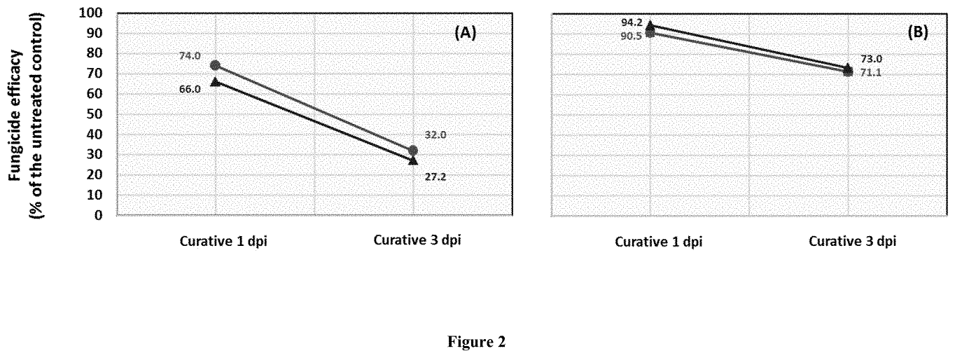

The fungicidal activity is shown in FIG. 2.

Curative efficacy of PTZ prototypes DT-WC-P1-W7M-1:2-05T was comparable to Proline 50EC.

### Test 1b: Preventive Treatment Test:

The prothioconazole-cyclodextrin were prepared in a volume of water corresponding to 200 l/ha (200-50-25-12.5 and 6.25 g/ha corresponding to 1000-250-125-62.5 and 31.25 mg a.i./L or ppm). Proline 50 EC and present invention compositions were pulverized by the aim of a hand sprayer. Controlled plants were treated with distilled water. Three replicated (pots) of 6 wheat plant each were used for each condition tested.

After treatment, wheat plants were left to dry at room temperature for 1 hour and then placed in a climatic chamber with a temperature of 24° C. day/18° C. night, photoperiod of 16 h light/8 hour dark and relative humidity of 65%.

Wheat leaf fragments of the first leaf were cut and transferred in Petri dish containing adapted water agar (6 leaf fragments per Petri dish). Leaf fragments were inoculated with a calibrated pycnospores suspension of Z. tritici strain Mg Tri-R6.

The fungicidal activity of prothioconazole-cyclodextrin prototype and Proline 50 EC compositions was measured.

It was found that prototype DT-WC-P1-W7M-1:2-05T (EC50 of 6.2 ppm) had a higher efficiency than the reference Proline 50 EC towards Z. tritici strain Mg Tri-R6.

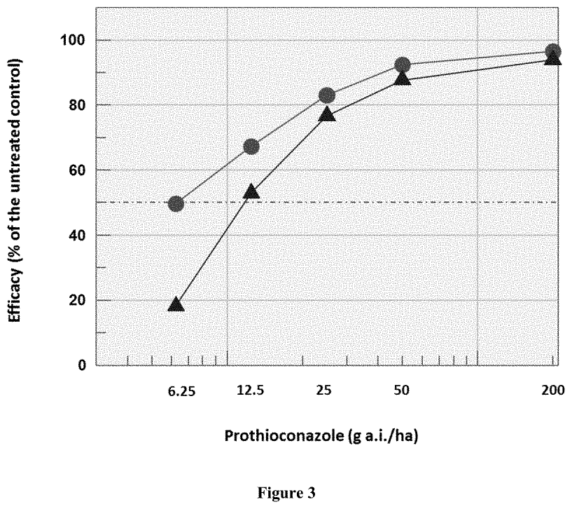

The efficacy results are shown in Table 1 and FIG. 3.

TABLE 1
EC₅₀ values of DT-WC-P1-W7M-1:2-05T and Proline
50EC towards Zymoseptoria Tritici (Syn. Mycosphaerella graminicola
) strain Mg Tri-R6.

| Product | EC₅₀ (μg PTZ/ml or ppm) |
|---|---|
| DT-WC-P1-W7M-1:2-05T | 6.2 |
| Proline 50EC | 12.5 |

### Test 1c: Persistence Efficiency Evaluation for Showing Prolonging the Biological Activity

Prothioconazole-Cyclodextrin prototype DT-WC-P1-W7M-1:2 and proline 50 EC compositions were tested at two rates of 25 and 50 g a.i./ha, corresponding to 125 and 250 μg a.i./ml or ppm, respectively. The fungicides were prepared in a volume of water corresponding to 200 l/ha and pulverized by the aim of a hand sprayer. Control seedlings were treated with distilled water. Three replicates (pots) of 6 wheat plants each were used for each condition tested.

After treatment, wheat plants were left to dry at room temperature for 1 hour and then placed in a climatic chamber: temperature of 24° C. day/18° C. night—photoperiod of 16 h light/8 h dark and a relative humidity of 65%.

Wheat leaf fragments of the first leaf were cut and transferred in Petri dish containing adapted water agar (6 leaf fragments per Petri dish). After periods of 1 week, 2 weeks and 3 weeks, leaf fragments were inoculated with a calibrated pycnospores suspension of Z. tritici strain Mg Tri-R6.

After inoculation, Petri dishes were placed in a climatic chamber: temperature of 20° C. day/17° C. night—photoperiod of 16 h light/8 h dark and controlled relative humidity.

The fungicidal activity of the prothioconazole-cyclodextrin prototype and Proline 50 EC compositions was measured.

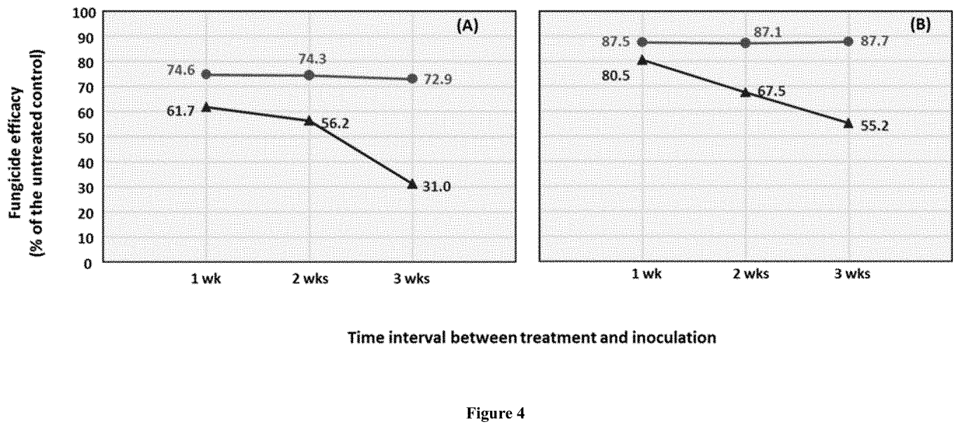

Prothioconazole (PTZ) applied at 125 ppm (25 g a.i./ha) (FIG. 4A): when inoculations were carried out 1 week after the treatment, the new PTZ-cyclodextrin prototype DT-WC-P1-W7M-1:2-05T exhibited a slightly higher efficacy than the reference PTZ Proline.

When inoculations were carried out 2 weeks after the treatment, the efficacy of the new PTZ prototype remained at the level observed at 1 week, while the effectiveness of Proline slightly decreased by 5%.

When inoculations were carried out 3 weeks after the treatment, the efficacy of the new PTZ-cyclodextrin prototype DT-WC-P1-W7M-1:2-05T still remained at the level observed at 1 week, while the effectiveness of the second PTZ-cyclodextrin prototype slightly decreased by 8% and that of Proline continued to decline by 25%.

PTZ applied at 250 ppm (50 g a.i./ha) (FIG. 4B): when inoculations were carried out 1 week after the treatment, the new PTZ-cyclodextrin prototype DT-WC-P1-W7M-1:2-05T still exhibited a slightly higher efficacy than the reference PTZ Proline.

When inoculations were carried out 2 weeks after the treatment, the efficacy of the new PTZ-cyclodextrin prototype remained at the level observed at 1 week, while the effectiveness of Proline slightly decreased by 13%.

When inoculations were carried out 3 weeks after the treatment, the efficacy of the new PTZ-cyclodextrin prototype DT-WC-P1-W7M-1:2-05T still remained at the level observed at 1 week, while the effectiveness of the second PTZ prototype slightly decreased by 6% and that of Proline continued to decline by 13%.

Our study showed that the new PTZ-cyclodextrin prototype DT-WC-P1-W7M-1:2-05T has a higher preventive efficiency as well as persistency than the reference Proline 50 EC towards Z. tritici strain Mg Tri-R6.

The results showed that the invention prothioconazole-cyclodextrin compositions prototype DT-WC-P1-W7M-1:2 brings an added value in terms of preventive efficiency and/or persistence compared to the reference Proline 50EC towards Z. tritici strain Mg Tri-R6.

Test 2. In Planta Evaluation of New Prothioconazole-Cyclodextrin Prototypes Fungicide Compositions Towards P. pachyrhizi Strain THAIl on Soybean.

### Test 2a Curative Treatment Test:

One (1) or three (3) days after the inoculation with the pathogen, inoculated soybean seedling were treated with distilled water (Control), DT-WC-P1-W7M-1:2-05T (75 g a.i./kg), DT-WC-P1-W7HP-1:2-06T (73 g a.i/kg), or Proline (250 g a.i./L) at two rates of 0.015 g a.i./ha and 0.045 g a.i./ha, corresponding to 0.1 and 0.3 ppm, respectively.

The fungicidal activity of prothioconazole-cyclodextrin prototypes and Proline 50 EC compositions was measured.

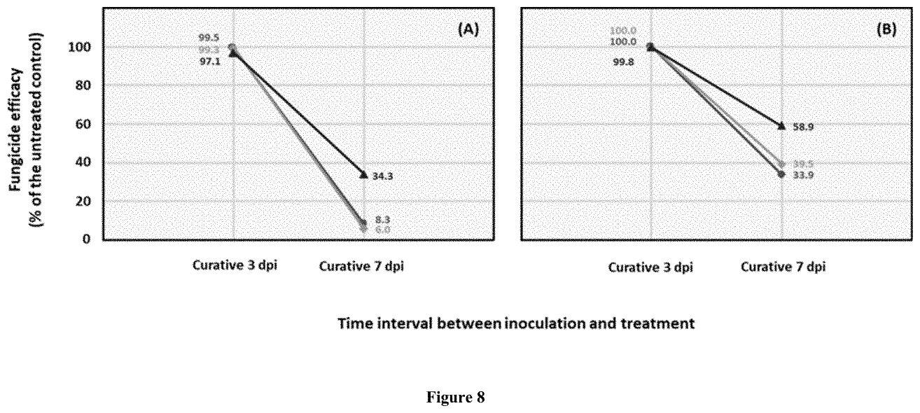

The fungicidal activity is shown in FIG. 8.

Results showed that PTZ prototypes DT-WC-P 1-W7M-1:2-05T and DT-WC-P1-W7HP-1:2-06T brought an added value in terms of curative efficacy compared to the reference Proline 50EC towards Asian soybean rust (Phakopsora pachyrhizi).

Test 2b. Preventing Treatment Test

First pair of true leaves unfolded (unifoliolate leaves on the first node) of soybean seedlings of a susceptible Asian rust cultivar (RAS04, RAGT) at the BBCH 12 growth stage were cut and treated on their adaxial face with water (Control), the new PTZ-cyclodextrin prototype compositions DT-WC-P1-W7M-1:2-05T or the reference Proline (EC at 250 g a.i./L) at five rates (0.045 g/ha-0.015 g/ha-0.0045 g/ha-0.0015 g/ha and 0.00045 g/ha , corresponding to 0.3-0.1-0.03-0.01 and 0.003 mg a.i./L or ppm). The Blank of composition of the new PTZ cyclodextrin prototypes DT-WC-P1-W7M-1:1-03B, were tested at one rate corresponding to the higher rate used for the corresponding PTZ -cyclodextrin prototype compositions (0.045 g/ha). The fungicides were prepared in a volume of water corresponding to 150 l/ha and pulverized by the aim of a hand sprayer. Control true leaves were treated with distilled water. After treatment, soybean leaves were let to dry at room temperature and then placed adaxial face up on 120×120 cm Petri dishes containing 0.4% water agar supplemented with antibiotic and anti-senescing product (3 replicates per treatment).

Twenty-four hours (24 h) after treatment (preventive treatment), soybean true leaves plantlets were inoculated with a calibrated uredospores suspension of the reference P. pachyrhizi strain THAIl. The inoculated soybean leaves were incubated in a climatic chamber.

The fungicidal activity of the prothioconazole-cyclodextrin prototype and Proline compositions is measured

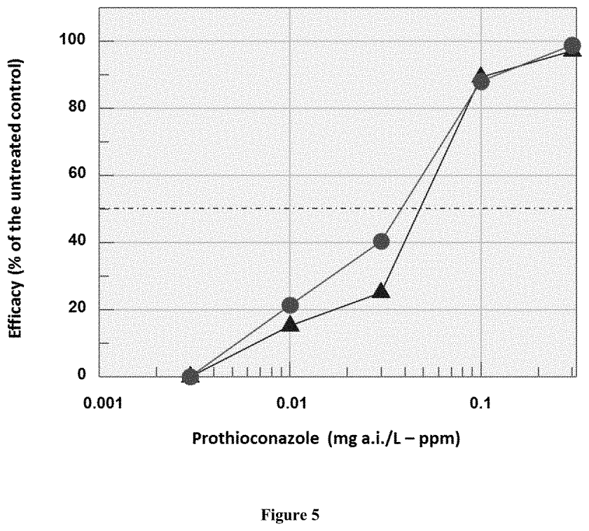

Results are shown in Table 2 and FIG. 5.

TABLE 2
EC₅₀ values of Prothioconazole-Cyclodextrin DT-WC-P1-
W7M-1:2-05T and Proline 50EC towards P. pachyrhizi strain
THAI1 on soybean leaves in controlled conditions.

| Product | EC₅₀ |
|---|---|
| DT-WC-P1-W7M-1:2-05T | 0.039 mg a.i./L or ppm (0.0059 g a.i./ha) |
| Proline 50EC | 0.049 mg a.i./L or ppm (0.0074 g a.i./ha) |

The results showed that the prototype DT-WC-P1-W7M-1:2-05T has a higher efficiency than the reference Proline 50EC towards P. pachyrhizi strain THAI1 on soybean leaves.

### Test 2c: Persistence Efficiency Evaluation

Prothioconazole-cyclodextrin prototypes DT-WC-P1-W7M-1:2 and DT-WC-P1-W7HP-1:2 and proline compositions were tested at two rates of 0.015 and 0.045 g a.i./ha, corresponding to 0.1 and 0.3 ppm, respectively. The fungicides were prepared in a volume of water corresponding to 200 l/ha and were pulverized by the aim of a hand sprayer. Control seedlings were treated with distilled water. Three replicates (pots) of 6 seedlings each were used for each condition tested.

After periods of 1 week, 2 weeks and 3 weeks, leaf fragments of treated Asian soybean were inoculated with a calibrated Asian soybean rust (Phakopsora pachyrhizi).

The fungicidal activity of the prothioconazole-cyclodextrin prototypes and the Proline 50 EC composition was measured.

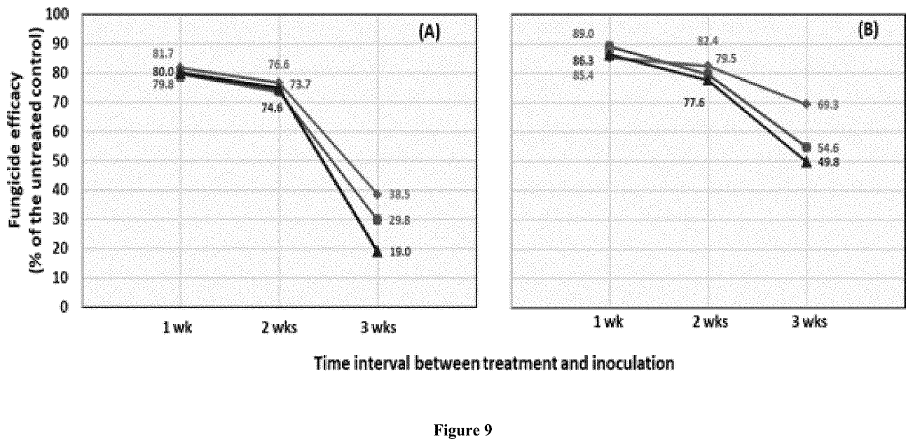

As shown in FIG. 9, results showed that the prothioconazole-cyclodextrin prototypes brought an added value in terms of persistence compared to the reference Proline 50EC towards Asian soybean rust (Phakopsora pachyrhizi).

### EXAMPLE 2

### Preparation of Epoxiconazole-Cyclodextrin Complexes

The preparation of the complexes is performed by suspending epoxiconazole into a solution of cyclodextrin at 50° C. at different weight and molar ratios. The content of epoxiconazole in the complex is determined by HPLC. Phase solubility isotherms are carried out for epoxiconazole-cyclodextrin complexes.

Cyclodextrin complexation of epoxiconazole is also performed by the co-precipitation method at pesticide-cyclodextrin weight % ratios of 1:1 to 1:5. After the reactions the solvent is evaporated and the dried cyclodextrin-pesticide complex is obtained.

The obtained epoxiconazole-cyclodextrin prototype is dissolved in water to obtain an aqueous composition.

The fungicidal efficacy of epoxiconazole in organic composition (commercial Soprano 125 SC) is compared to the fungicidal efficacy of epoxiconazole-cyclodextrin prototype. Epoxiconazole is used against different pathogens such as Septoria, and Asian soybean rust in different crops and the efficacy is measured.

### Test 1. In Planta Evaluation of New Epoxiconazole-Cyclodextrin Prototypes Fungicide Compositions Towards Asian Soybean Rust in Soybean.

### Test 1a: Curative Treatment Test:

One (1) or three (3) days after the inoculation with the pathogen, inoculated soybean leaf fragments are treated with distilled water (Control), with epoxiconazole-cyclodextrin and Soprano 125SC.

The fungicidal activity of epoxiconazole-cyclodextrin prototypes and Soprano 125 SC compositions is measured.

Results show that the invention epoxiconazole-cyclodextrin prototype composition brings an added value in terms of curative treatment compared to the reference Soprano 125SC towards Asian soybean rust (Phakopsora pachyrhizi) in soybean

### Test 1b: Preventive Treatment Test:

The epoxiconazole-cyclodextrin compositions are prepared. Soprano 125 SC and present invention compositions are pulverized by the aim of a hand sprayer. Controlled seedlings are treated with distilled water. Three replicated (pots) of 6 soybean plant each are used for each condition tested.

After treatment, soybean plants are left to dry at room temperature for 1 hour and then placed in a climatic chamber with a temperature of 24° C. day/18° C. night, photoperiod of 16 h light/8 hour dark and relative humidity of 65%.

Soybean leaf fragments of the first leaf are cut and transferred in Petri dish containing adapted water agar (6 leaf fragments per Petri dish). Leaf fragments are inoculated with Asian soybean rust (Phakopsora pachyrhizi).

The fungicidal activity of epoxiconazole-cyclodextrin prototype and Soprano 125 SC compositions is measured.

Results show that the invention epoxiconazole-cyclodextrin prototype composition brings an added value in terms of preventing compared to the reference Soprano 125 SC towards Asian soybean rust (Phakopsora pachyrhizi).

### Test 1c: Persistence Efficiency Evaluation

Prototype epoxiconazole-cyclodextrin and Soprano 125 SC compositions are tested. The fungicides are prepared in water and are pulverized by the aim of a hand sprayer. Control seedlings are treated with distilled water. Three replicates (pots) of 6 soybean plants each are used for each condition tested.

After periods of 1 week, 2 weeks and 3 weeks, leaf fragments of treated soybean leaf are inoculated with a calibrated Asian soybean rust (Phakopsora pachyrhizi)

The fungicidal activity of the epoxiconazole-cyclodextrin prototype and Soprano compositions is measured.

Results show that the invention epoxiconazole-cyclodextrin prototype composition brings an added value in terms of persistence compared to the reference Soprano 125 SC towards Asian soybean rust (Phakopsora pachyrhizi).

### Test 2: In Planta Evaluation of New Epoxiconazole-Cyclodextrin Prototypes Fungicide Compositions Towards Septoria in Wheat (Cereal).

### Test 2a: Curative Treatment Test

One (1) or three (3) days after inoculation with the pathogen, inoculated wheat leaf fragments are treated with distilled water (Control), with epoxiconazole-cyclodextrin or Soprano (125SC).

The fungicidal activity of the epoxiconazole-cyclodextrin prototype and Soprano 125 SC compositions is measured.

Results show that the invention epoxiconazole-cyclodextrin prototype composition brings an added value in terms of curative treatment efficiency compared to the reference Soprano 125 SC towards Septoria in wheat.

### Test 2b: Preventive Treatment Test:

The epoxiconazole-cyclodextrin compositions are prepared. Soprano 125 SC and present invention compositions are pulverized by the aim of a hand sprayer. Controlled plants are treated with distilled water. Three replicated (pots) of 6 wheat plant each are used for each condition tested.

After treatment, wheat plants are left to dry at room temperature for 1 hour and then placed in a climatic chamber with a temperature of 24° C. day/18° C. night, photoperiod of 16 h light/8 hour dark and relative humidity of 65%.

Wheat leaf fragments of the first leaf are cut and transferred in Petri dish containing adapted water agar (6 leaf fragments per Petri dish). Leaf fragments are inoculated with Septoria Z. tritici strain Mg Tri-R6.

The fungicidal activity of epoxiconazole-cyclodextrin prototype and Soprano 125 SC compositions is measured.

Results show that the invention epoxiconazole-cyclodextrin prototype composition brings an added value in terms of preventing compared to the reference Soprano 125 SC towards Septoria Z. tritici strain Mg Tri-R6.

### Test 3c: Persistence Efficiency Evaluation

Prototype epoxiconazole-cyclodextrin and Soprano 125 SC compositions are tested. The fungicides are prepared in water and are pulverized by the aim of a hand sprayer. Control plants are treated with distilled water. Three replicates (pots) of 6 wheat plants each are used for each condition tested.

After periods of 1 week, 2 weeks and 3 weeks, leaf fragments of treated wheat leaf are inoculated with a calibrated Septoria Z. tritici strain Mg Tri-R6.

After treatment, wheat plants are left to dry at room temperature for 1 hour and then placed in a climatic chamber: temperature of 24° C. day/18° C. night—photoperiod of 16 h light/8 h dark and a relative humidity of 65%.

The fungicidal activity of the epoxiconazole-cyclodextrin prototype and the Soprano is measured.

Results show that the invention epoxiconazole-cyclodextrin prototype composition brings an added value in terms of persistence compared to the reference Soprano 125 SC towards Z tritici strain Mg Tri-R6.

### EXAMPLE 3

### Preparation of Propiconazole-Cyclodextrin Complexes

The preparation of the complexes is performed by suspending propiconazole into a solution of cyclodextrin at 50° C. at different weight and molar ratios. The content of propiconazole in the complex is determined by HPLC. Phase solubility isotherms are carried out for propiconazole-cyclodextrin complexes.

cyclodextrin complexation of propiconazole is also performed by the co-precipitation method at pesticide-cyclodextrin weight % ratios of 1:1 to 1:5. After the reactions the solvent is evaporated and the dried cyclodextrin-pesticide complex is obtained.

The obtained propiconazole-cyclodextrin prototype is dissolved in water to obtain an aqueous composition.

The fungicidal efficacy of propiconazole in organic composition (commercial Tilt 250 EC) is compared to the fungicidal efficacy of propiconazole -cyclodextrin prototype. Propiconazole is used against different pathogens such as Septoria, and Asian soybean rust in different crops and the efficacy is measured.

Test 1. In Planta Evaluation of New Propiconazole-Cyclodextrin Prototypes Fungicide Compositions Towards Asian Soybean Rust (Phakopsora pachyrhizi) in Soybean.

### Test 1a: Curative Treatment Test:

One (1) or three (3) days after the inoculation with the pathogen, inoculated soybean leaf fragments are treated with distilled water (Control), with propiconazole-cyclodextrin or Tilt 250 EC.

The fungicidal activity of the propiconazole-cyclodextrin prototype and Tilt 250 EC compositions is measured.

Results show that the invention propiconazole-cyclodextrin prototype composition brings an added value in terms of curative treatment efficiency compared to the reference Tilt 250 EC towards Asian soybean rust (Phakopsora pachyrhizi) in soybean.

### Test 1b: Preventive Treatment Test:

The propiconazole-cyclodextrin compositions are prepared. Tilt 250 EC and present invention compositions are pulverized by the aim of a hand sprayer. Control seedlings are treated with distilled water. Three replicated (pots) of 6 soybean plant each are used for each condition tested.

After treatment, soybean plants are left to dry at room temperature for 1 hour and then placed in a climatic chamber with a temperature of 24° C. day/18° C. night, photoperiod of 16 h light/8 hour dark and relative humidity of 65%.

Soybean leaf fragments of the first leaf are cut and transferred in Petri dish containing adapted water agar (6 leaf fragments per Petri dish). Leaf fragments are inoculated with Asian soybean rust (Phakopsora pachyrhizi)

The fungicidal activity of propiconazole-cyclodextrin prototype and Tilt 250 EC compositions is measured.

Results show that the invention propiconazole-cyclodextrin prototype composition brings an added value in terms of preventing compared to the reference Tilt 250 EC towards Asian soybean rust.

### Test 1c: Persistence Efficiency Evaluation

Prototype propiconazole-cyclodextrin and Tilt 250 EC compositions are tested. The fungicides are prepared in water and are pulverized by the aim of a hand sprayer. Control seedlings are treated with distilled water. Three replicates (pots) of 6 soybean plants each are used for each condition tested.

After periods of 1 week, 2 weeks and 3 weeks, leaf fragments of treated soybean leaf are inoculated with a calibrated Asian soybean rust (Phakopsora pachyrhizi).

The fungicidal activity of the propiconazole-cyclodextrin prototype and Tilt 250 EC compositions is measured.

Results show that the invention propiconazole-cyclodextrin prototype composition brings an added value in terms of persistence compared to the reference Tilt 250 EC towards Asian soybean rust (Phakopsora pachyrhizi).

### Test 2: In Planta Evaluation of New Propiconazole-Cyclodextrin Prototypes Fungicide Compositions Towards Septoria in Wheat (Cereal).

### Test 2a: Curative Treatment Test

One (1) or three (3) days after inoculation with the pathogen, inoculated wheat leaf fragments are treated with distilled water (Control), with propiconazole-cyclodextrin or Tilt 250 EC.

The fungicidal activity of the propiconazole-cyclodextrin prototype and Tilt 250 EC compositions is measured.

Results show that the invention propiconazole-cyclodextrin prototype composition brings an added value in terms of curative treatment compared to the reference Tilt 250 EC towards Septoria in wheat.

### Test 2b: Preventive Treatment Test:

The propiconazole-cyclodextrin compositions are prepared. Tilt 250 EC and present invention compositions are pulverized by the aim of a hand sprayer. Controlled seedlings are treated with distilled water. Three replicated (pots) of 6 wheat plant each are used for each condition tested.

After treatment, wheat plants are left to dry at room temperature for 1 hour and then placed in a climatic chamber with a temperature of 24° C. day/18° C. night, photoperiod of 16 h light/8 hour dark and relative humidity of 65%.

Wheat leaf fragments of the first leaf are cut and transferred in Petri dish containing adapted water agar (6 leaf fragments per Petri dish). Leaf fragments are inoculated with Septoria Z . tritici strain Mg Tri-R6

The fungicidal activity of propiconazole-cyclodextrin prototype and Tilt 250 EC compositions is measured.

Results show that the invention propiconazole-cyclodextrin prototype composition brings an added value in terms of preventing compared to the reference Tilt 250 EC towards Septoria Z. tritici strain Mg Tri-R6.

### Test 2c: Persistence Efficiency Evaluation

Prototype propiconazole-cyclodextrin and Tilt 250 EC compositions are tested. The fungicides are prepared in water and are pulverized by the aim of a hand sprayer. Control seedlings are treated with distilled water. Three replicates (pots) of 6 wheat plants each are used for each condition tested.

After periods of 1 week, 2 weeks and 3 weeks, leaf fragments of treated wheat leaf are inoculated with a calibrated Z tritici strain Mg Tri-R6.

The fungicidal activity of the propiconazole-cyclodextrin prototype and Tilt 250 EC compositions is measured.

Results show that the invention propiconazole-cyclodextrin composition prototypebrings an added value in terms of persistence compared to the reference Tilt 250 EC towards Z tritici strain Mg Tri-R6.

### EXAMPLE 4

### Preparation of Tau-Fluvalinate-Cyclodextrin Complexes

The preparation of the tau-fluvalinate-cyclodextrin complexes was performed by the melting-in method by suspending tau-fluvalinate into an aqueous solution of cyclodextrin at 50° C. The ratio of starting materials was 1:1. The content of tau-fluvalinate in the complex was determined by HPLC. Following preliminary phase solubility studies with different cyclodextrins, Cavasol W7M which resulted in best solubility enhancement was used to prepare the cyclodextrin complexes with tau-fluvalinate at weight % ratios of 1:1 to 1:5.

Cyclodextrin complexation of tau-fluvalinate with CAVASOL® W7M was also performed by the co-precipitation method at pesticide-cyclodextrin weight % ratios of 1:1 to 1:5. It was prepared by dissolving both the pesticide and the cyclodextrin into acetone. After the reactions, the solvent was evaporated, and the dried cyclodextrin-pesticide complex was obtained.

Tau-fluvalinate was chemically interacted with cyclodextrin to form the complexed tau-fluvalinate cyclodextrin molecular assembly. The resulted guest-host complex was dissolved in water to obtain an aqueous composition. A suspoemulsion composition comprising tau-fluvalinate (Mavrik) was tested versus the cyclodextrin-complexed composition.

Insecticidal efficacy of tau-fluvalinate-cyclodextrin prototype was compared to commercial Mavrik product. The efficacy was tested in different crops with two types of pests (Aphids and Lepidoptera)—Aphids in peach and wheat [Green Peach Aphids Myzus prsicae and Wheat (Bird cherry) Aphids Rhopalosiphum padi]; and Lepidoptera Spodoptera littoralis in pepper, wheat and castor.

### Test 1: In Planta Evaluation of New Tau-Fluvalinate-Cyclodextrin Prototypes Insecticide Compositions Towards Spodoptera Littoralis on Castor Oil Leaves.

### Test 1: Knock Down Treatment Test:

Castor oil seedlings were treated with various of concentrations prototype taufluvalinate-cyclodextrin and Mavrik (24%). The treated castor oil seedlings were exposed to S. litoralis L.1 for 3 days.

The insecticidal acyivity of tau-fluvalinate-cyclodextrin prototypes and Mavrik compositions was measured.

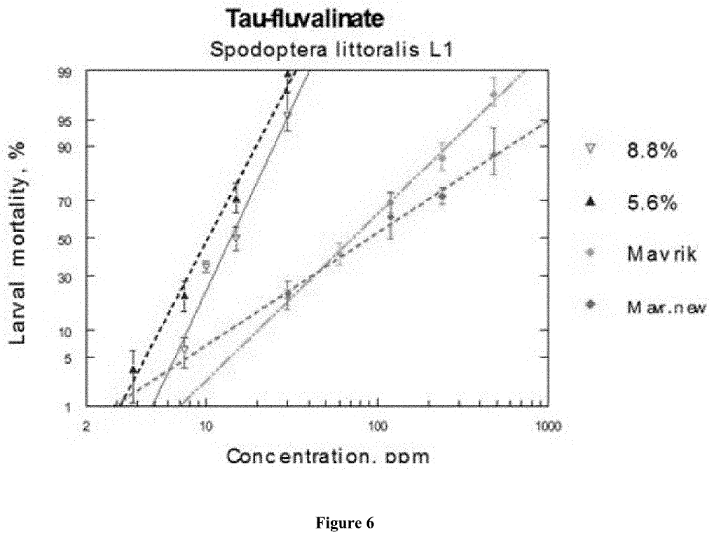

Toxicity values (insecticidal activity) of tau-fluvalinate-cyclodextrin DT-WC-T1-W7M-1:3, DT-WC-T1-W7M-1:5 and Mavrik towards Spodoptera Littoralis on Castor oil leaves are summarized in Tables 3,4 and FIG. 6. Effects of tau-fluvalinate on 1st instars S. littoralis are also summarized in Table 3, 4 and FIG. 6.

TABLE 3

| Composition | LD50 - ppm AI | LD90 - ppm AI |
|---|---|---|
| Mavrik - commercial | 102 | 342 |
| DT-WC-T1-W7M-1:3-09T | 16 | 26 |
| DT-WC-T1-W7M-1:5-10T | 10 | 21 |

TABLE 4
Tau-fluvalinate on S. littoralis L1

| | | | LC₁₀ | LC₅₀ | LC₉₀ |
|---|---|---|---|---|---|
| Formulation | n | Slope ± SEM | (F.L) | (F.L) | (F.L) |
| DT-WC-T1-W7M-1:5- | 332 | 4.52 ± 0.45 | 5.7 | 11 | 21 |
| 10T(5.6%) | | | (3.1-7.6) | (9-14) | (16-37) |
| DT-WC-T1-W7M-1:3- | 308 | 5.00 ± 0.47 | 7.9 | 14 | 26 |
| 09T(8.8%) | | | (2.8-10.9) | (10-21) | (18-84) |
| Mavrik | 370 | 2.27 ± 0.23 | 20 | 73 | 266 |
| | | | (13-27) | (60-86) | (214-357) |
| Mavrik (new) | 201 | 1.57 ± 0.24 | 14 | 89 | 587 |
| BN-961101081 | | | (5-24) | (63-118) | (381-1225) |

For tau-fluvalinate, an improvement of knock down effect for the invention prototype, was well shown, which means higher mortality at lower rates.

Test 2: In Planta Evaluation of New Tau-Fluvalinate-Cyclodextrin Prototypes Insecticide Compositions Towards Wheat Aphid (Rhopalosiphum padi)

### Test 2: Persistence Efficiency Evaluation

Wheat plants were treated with various prototypes tau-fluvalinate-cyclodextrin (DT-WC-T1-W7M-1:3, DT-WC-T1-W7M-1:5) and Mavrik (24%) in different concetrations. After 3, 7, 14 and 21 days, the treated wheat plants, were exposed to wheat Aphid(Rhopalosiphum padi).

The insecticidal activity of tau-fluvalinate-cyclodextrin prototypes and Mavrik compositions was measured.

Results are summarized in table 5:

TABLE 5

| Delay between treatment and | Efficacy observed 7 days after infestation | | | |
|---|---|---|---|---|
| infestation | 1 DAT | 3 DAT | 7 DAT | 14 DAT |
| Tau-F 3N | 58% | 59% | 59% | 14% |
| Tau-F 9N | 92% | 93% | 58% | 57% |
| 1:3-09T 3N | 70% | 78% | 73% | 67% |
| 1:3-09T 9N | 99% | 100% | 97% | 91% |
| 1:5-10T 3N | 97% | 95% | 48% | 51% |
| 1:5-10T 9N | 100% | 97% | 96% | 68% |

Results showed that the invention tau-fluvalinate-cyclodextrin compositions prototypes DT-WC-T1-W7M-1:3, DT-WC-T1-W7M-1:5 bring an added value in terms of persistence compared to the reference Mavrik towards wheat Aphid (Rhopalosiphum padi) on wheat plant.

Test 3: In Planta Evaluation of New Tau-Fluvalinate-Cyclodextrin Prototypes Insecticide Composition towards Green Peach Aphids Myzus Prsicae.

### Test 3a: Knock Down Treatment Test:

Peach leaves were treated with various of concentrations of tau-fluvalinate-cyclodextrin prototypes (DT-WC-T1-W7M-1:3, DT-WC-T1-W7M-1:5) and Mavrik (24%). The treated peach leaves were exposed to Myzus prsicae for 3 days.

The insecticidal activity of tau-fluvalinate-cyclodextrin prototypes and Mavrik compositions was measured.

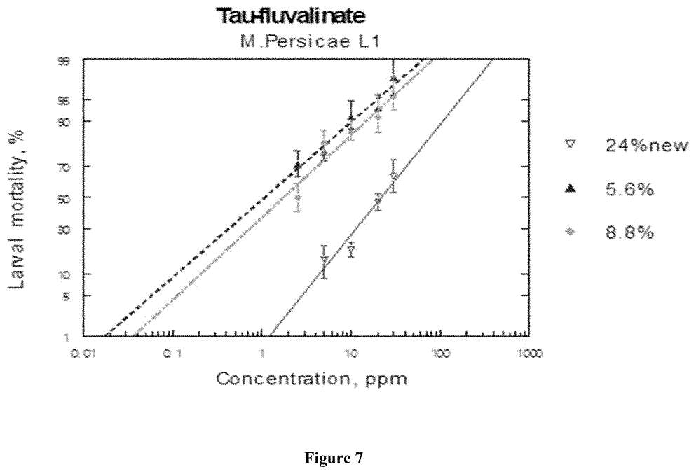

Results are shown in Table 6 and FIG. 7.

TABLE 6
Effect of Tau-fluvalinate on M. persicae

| | | | LC₅₀ | LC₉₀ |
|---|---|---|---|---|
| Formulation | n | Slope ± SEM | (F.L.) | (F.L.) |
| DT-WC-T1-W7M-1:5- | 250 | 1.24 ± 0.30 | 0.98 | 10.53 |
| 10T(5.6%) | | | (0.15-1.97) | (7.01-21.07) |
| DT-WC-T1-W7M-1:3- | 254 | 1.46 ± 0.27 | 1.87 | 14.04 |
| 09T(8.8%) | | | (0.79-2.91) | (9.84-25.60) |
| Mavrik (new) | 282 | 2.04 ± 0.41 | 21.19 | 89.99 |
| BN-961101081 | | | (16.83-28.56) | (54.37-277.73) |

Results showed that the invention tau-fluvalinate-cyclodextrin prototypes DT-WC-T1-W7M-1:3 and DT-WC-T1-W7M-1:5 compositions bring an added value in terms of knock down treatment compared to the reference Mavrik towards Green Peach Aphids Myzus prsicae.

### Test 3b: Persistence Efficiency Evaluation

Peach leaves are treated with various tau-fluvalinate-cyclodextrin prototypes (DT-WC-T1-W7M-1:3, DT-WC-T1-W7M-1:5) and Mavrik (24%) in different concentrations. After 3, 7, 14 and 21 days, the treated castor oil seedlings, are exposed to Green Peach Aphids Myzus prsicae.

The insecticidal activity of tau-fluvalinate-cyclodextrin prototypes and Mavrik compositions is measured

Results show that the invention tau-fluvalinate-cyclodextrin compositions prototypes DT-WC-T1-W7M-1:3 and DT-WC-T1-W7M-1:5 bring an added value in terms of persistence compared to the reference Mavrik towards Green Peach Aphids Myzus prsicae.

### EXAMPLE 5

### Preparation of Bifenthrin-Cyclodextrin Complexes

The preparation of the bifenthrin-cyclodextrin complexes is performed by the melting-in method by suspending bifenthrin into an aqueous solution of cyclodextrin at 50° C. at different weight and molar ratios. The content of bifenthrin in the complex is determined by HPLC.

Cyclodextrin complexation of bifenthrin is also performed by the co-precipitation method at pesticide-cyclodextrin weight % ratios of 1:1 to 1:5. It is prepared by dissolving both the pesticide and the cyclodextrin into acetone. After the reactions, the solvent is evaporated, and the dried cyclodextrin-pesticide complex is obtained.

Bifenthrin is chemically interacted with cyclodextrin to form the complexed bifenthrin cyclodextrin molecular assembly. The resulting guest-host complex is dissolved in water to obtain an aqueous composition. An emulsifiable concentrate of bifenthrin (Cheminova 250 EC) is tested versus the cyclodextrin-complexed composition.

Insecticidal efficacy of bifenthrin-cyclodextrin prototype is compared to commercial Cheminova 250 EC. The efficacy is tested in different crops with two types of pests (Aphids and Lepidoptera) in castor oil leaves, wheat, oil seed rape and cotton.

### Test 1: In Planta Evaluation of New Bifenthrin-Cyclodextrin Prototypes Insecticide Compositiontowards Spodoptera Littoralis on Castor Oil Leaves.

### Test 1a: Knock Down Treatment Test:

Castor oil seedlings are treated with various of concentrations prototype bifenthrin-cyclodextrin and Cheminova 250 EC. The treated seedlings are exposed to Spodoptera Littoralis for 3 days.

The insecticidal of bifenthrin-cyclodextrin prototype and Cheminova 250 EC compositions is measured.

Results show that bifenthrin-cyclodextrin compositions bring an added value in terms of knock down treatment compared to the reference Cheminova 250 EC towards Spodoptera Littoralis on castor oil leaves.

Analogous results are observed in wheat, oil seed rape and cotton.

### Test 1b: Persistence Efficiency Evaluation

Castor oil seedlings are treated with various prototypes bifenthrin-cyclodextrin and Cheminova 250 EC in different concetrations. After 3, 7, 14 and 21 days, the treated castor oil leaves are exposed to S. litoralis L.1.

The insecticidal activity of bifenthrin-cyclodextrin prototype and Cheminova 250 EC compositions is measured.

Results show that the invention bifenthrin-cyclodextrin prototypes composition bring an added value in terms of persistence compared to the reference Cheminova towards Spodoptera Littoralis on castor oil leaves.

Analogous results are observed in wheat, oil seed rape and cotton.

### EXAMPLE 6

### Preparation of Deltamithrin-Cyclodextrin Complexes

The preparation of the deltamithrin-cyclodextrin complexes is performed by the melting-in method by suspending deltamithrin into an aqueous solution of cyclodextrin at 50° C. at different weight and molar ratios. The content of deltamithrin in the complex is determined by HPLC.

Cyclodextrin complexation of deltamithrin is also performed by the co-precipitation method at pesticide-cyclodextrin weight % ratios of 1:1 to 1:5. It is prepared by dissolving both the pesticide and the cyclodextrin into acetone. After the reactions, the solvent is evaporated, and the dried cyclodextrin-pesticide complex is obtained.

Deltamithrin is chemically interacted with cyclodextrin to form the complexed bifenthrin cyclodextrin molecular assembly. The resulting guest-host complex is dissolved in water to obtain an aqueous composition. An emulsifiable concentrate of deltamithrin (k-Obiol 25 EC) is tested versus the cyclodextrin-complexed composition.

Insecticidal activity of deltamithrin-cyclodextrin prototype is compared to commercial k-Obiol 25 EC. The activity is tested in different crops with two types of pests (Aphids and Lepidoptera) in wheat and castor oil leaves.

### Test 1: In Planta Evaluation of New Deltamithrin-Cyclodextrin Prototypes Insecticide Compositioncompositions Towards Spodoptera Littoralis on on Castor Oil Leaves

### Test 1a: Knock Down Treatment Test:

Castor oil seedlings are treated with various of concentrations prototype deltamithrin-cyclodextrin and k-Obiol 25 EC. The treated seedlings are exposed to Spodoptera Littoralis for 3 days.

The insectivcidal activity of deltamithrin-cyclodextrin prototype and k-Obiol compositions is measured.

Results show that invention deltamithrin-cyclodextrin prototypes compositions bring an added value in terms of knock down treatment compared to the reference k-Obiol 25 EC towards Spodoptera Littoralis on castor oil leaves.

Analogous results are observed in wheat.

### Test 1b: Persistence Efficiency Evaluation

Castor oil seedlings are treated with various prototypes deltamithrin -cyclodextrin and k-Obiol in different concetrations. After 3, 7, 14 and 21 days, the treated seedlings are exposed to S. litoralis L.1.

The insecticidal activity of deltamithrin-cyclodextrin prototype and k-Obiol 25 EC compositions is measured.

Results show that the invention deltamithrin-cyclodextrin prototypes compositions bring an added value in terms of persistence compared to the reference k-Obiol 2 EC towards Spodoptera Littoralis on castor oil leaves.

Analogous results are observed in wheat.

1. A composition comprising an effective amount of (i) a pesticide selected from the group consisting of tau-fluvalinate, prothioconazole, and a mixture thereof, and (ii) cyclodextrin, wherein the pesticide molecules interact chemically with the cyclodextrin molecular matrix through intermolecular force (s).

2. The composition of claim 1, wherein the cyclodextrin is α (alpha)-cyclodextrin, β (beta)-cyclodextrin, or γ (gamma)-cyclodextrin.

3. The composition of claim 1, wherein the cyclodextrin is alkylated.

4. The composition of claim 1, wherein the cyclodextrin is a methyl-beta-cyclodextrin, a hydroxypropyl-beta-cyclodextrin, or a hydroxypropyl-gamma-cyclodextrin.

5. The composition of claim 1, wherein the cyclodextrin has the following structure: 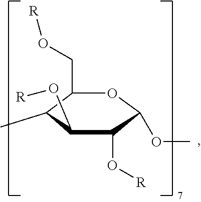
wherein R is H or methyl.

6. The composition of claim 1, wherein the cyclodextrin has the following structure: 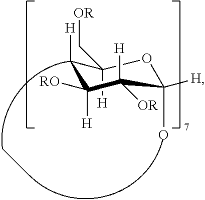
wherein R is 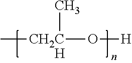
and n is an integer equal to or greater than 0.

7. The composition of claim 1, wherein the pesticide has a log P value between 1 to 7.

8-11. (canceled)

12. The composition of any one of claim 1-7, wherein:
a the concentration of the cyclodextrin in the composition is between 0.1 to 20 g/kg,
b. the concentration of the pesticide in the composition is between 0.1 to 20 g/kg,
c. the amount of the cyclodextrin in the composition is 10-90% by weight based on the total weight of the composition, and/or
d. the amount of the pesticide in the composition is 10-50% by weight based on the total weight of the composition.

13. The composition of claim 1, wherein:
a the weight ratio between the pesticide and the cyciodextrin in the composition is from 1:5 to 1:1, and/or
b) the molar ratio between the pesticide and the cyclodextrin in the composition is from 1:1 to 1:10.

14. (canceled)

15. The composition of claim 1, wherein the pesticide molecules are complexed with or encapsulated within the cyclodextrin molecular matrix.

16. The composition of claim 1, wherein the composition further comprises an agriculturally acceptable carrier, at least one additive, and/or one or more additional agrochemicals.

17. The composition of claim 1, wherein the composition is free of any adjuvant.

18. A pesticidal guest/host inclusion complex or delivery system comprising (i) a pesticide selected from the group consisting of tau-fluvalinate, prothioconazole, and a mixture thereof, and (ii) cyclodextrin, wherein:
a) in the pesticidal guest/host inclusion complex, the pesticide is the guest and the cyclodextrin is the host, and
b) in the pesticidal delivery system, the pesticide interacts chemically with the cyclodextrin through intermolecular force (s).

19. The pesticidal guest/host inclusion complex of claim 18, wherein:
a) the guest/host inclusion complex comprises guest prothioconazole and host methylated β-cyclodextrin at a weight ratio of 1:2,
b) the guest/host inclusion complex comprises guest tau-fluvalinate and host methylated β-cyclodextrin at a weight ratio from 1:3 to 1:5.

20. (canceled)

21. A method of controlling pest using a pesticide, prolonging the pesticidal effect of a pesticide and/or increasing retention of a pesticide by a plant comprising contacting (i) the pest or a locus thereof, (ii) a plant or a locus or propagation material thereof, (iii) soil, and/or (iv) an area in which pest infestation is to be prevented with the composition of claim 1.

22. The method of claim 21, wherein:
a) the pest is a phytopathogenic fungi or an unwanted insect, and/or
b) the composition is applied at a rate of 1 g a.i./ha to 100 g a.i./ha or the composition is applied at a rate of 6.25 g a.i./ha, 12.5 g a.i. a.i./ha, or 50 g a i./ha.

23. (canceled)

24. (canceled)

25. The method of claim 21, wherein the method is effective for:
a) preventing infestation of the pest,
b) curing infestation of the pest,
c) increasing the pesticidal activity of the pesticide,
d) prolonging the pesticidal effect of the pesticide,
e) increasing retention. of the pesticide by the plant,
f) increasing the bioavailablity of the pesticide to the plant,
g) decreasing the half maximal effective concentration (EC₅₀) of the pesticide,
h) decreasing the lethal concentration 50 (LC₅₀) of the pesticide, and/or
i) decreasing the legal concentration 90 (LC₉₀) of the pesticide.

26. The method of claim 21, wherein:
a) the method further comprises applying at least one additional agrochemical to (i) the pest or a locus thereof, (ii) a plant or a locus or propagation material thereof, (iii) soil, and/or (iv) an area in which pest infestation is to be prevented, and/or
b) the method further comprises applying an additional adjuvant.

27. The composition of claim 26, wherein:
a) the composition is tank mixed with the additional agrochemical or applied sequentially with the additional agrochemical, and/or
b) the composition is tank mixed with the additional adjuvant or applied sequentially with the additional adjuvant.

28. (canceled)

29. (canceled)

30. (canceled)

31. A method for (i) increasing the biological activity of prothioconazole and/or tau fluvalinate on a plant, (ii) increasing the retention of prothioconazole and/or tau fluvalinate by a plant, or (iii) increasing the bioavailability of prothioconazole and/or tau fluvalinate to a plant comprising interacting chemically the prothioconazole and/or tau fluvalinate with cyclodextrin through intermolecular force(s) prior to application of the prothioconazole and/or tau fluvalinate to the plant and/or soil.

32-36. (canceled)
